(19) United States
(12) Patent Application Publication
(10) Pub. No.: US 2009/0326703 A1
(43) Pub. Date: Dec. 31, 2009

(54) INTEGRATED MINIATURE MICROELECTRONIC DEVICE FACTORY

(76) Inventors: BRYAN S. PRESLEY, Allen, TX (US); JEFFREY N. MILLER, Allen, TX (US)

Correspondence Address: HOWISON & ARNOTT, L.L.P, P.O. BOX 741715, DALLAS, TX, 75374-1715, US

(21) Appl. No.: 12/112,727

(22) Filed: Apr. 30, 2008

Related U.S. Application Data
(60) Provisional application No. 60/915,112, filed on Apr. 30, 2007.

(51) Int. Cl. G06F 19/00; G06F 3/048

(52) U.S. Cl. 700/112; 700/121; 715/771

(57) ABSTRACT

An integrated miniature factory for fabrication of a device is provided. In one example, the factory includes an enclosure, multiple compartmentalized process modules, and a transportation mechanism. The compartmentalized process modules are configured to removably couple to the enclosure. Each compartmentalized process module is sized to receive a substrate on which the device is to be fabricated and is configured to aid in fabrication of the device. The transportation mechanism is configured to transfer the substrate between at least two of the compartmentalized process modules during a fabrication process.

### CROSS-REFERENCE

The present disclosure claims priority from U.S. Provisional Patent Application Ser. No. 60/915,112, filed on Apr. 30, 2007, which is hereby incorporated by reference in its entirety.

### FIELD

The present disclosure is directed to equipment for the fabrication of microelectronic devices, and more particularly, to an integrated miniature microelectronic device factory.

### BACKGROUND

The exploding cost to build and operate a fabrication facility (a “fab”) for advanced microelectronics and the combined technical hurdles surrounding the design of the next generation of chips has compelled chipmakers to outsource to low cost sites at an aggressive rate. Chipmakers frequently race to bring new products to market at the lowest possible cost to maintain and gain market share. Process development and proto-typing is a significant portion of the cost to bring new products to the market, and outsourcing to fabs that provide manufacturing services to multiple customers is increasingly common.

Advanced microelectronic devices are fabricated on wafers typically ranging in diameter from 150 mm up to 400 mm. Fabricating advanced microelectronic devices is expensive and therefore the cost to fabricate such devices typically limits the variety and number of products that a particular chipmaker chooses to fabricate. At least partly as a result of such selective fabrication, many companies are unable to create new products in a timely manner or to offer a wide variety of products. Moreover, today's advanced microelectronics fabs may cost over three billion dollars to build. Not only are the newer fabs often quite large with an area on the order of 180,000 square feet, but they typically include an extensive infrastructure to deliver chemicals, gases, and power to manufacturing equipment inside a clean room environment. As new fabs are built to fabricate microelectronic devices on larger wafers, the amounts of material, chemical, gas, and electricity that are wasted may exponentially increase. Furthermore, as microelectronic device technologies shrink and the manufacturing equipment increases in size to accommodate larger wafers to fabricate these devices in high volume, the ability to create new products in a timely manner and/or a wide variety of products is further limited. Accordingly, there is a need for a system and method to provide a low cost means for fabricating low volume products and for fabricating products in a manner that is environmentally responsible.

### SUMMARY

In one embodiment, an integrated miniature factory for fabrication of a device is provided. The integrated miniature factory comprises an enclosure, a plurality of compartmentalized process modules, and a transportation mechanism. The plurality of compartmentalized process modules are configured to removably couple to the enclosure. Each of the compartmentalized process modules are sized to receive a substrate on which the device is to be fabricated, and each of the compartmentalized process modules are configured to aid in fabrication of the device. The transportation mechanism is configured to transfer the substrate between at least first and second compartmentalized process modules of the plurality of compartmentalized modules during a fabrication process.

In another embodiment, a process module for use in an integrated miniature factory is provided. The process module includes a body containing a process chamber sized to receive a substrate and processing components configured to perform processing on the substrate. A tool status screen coupled to the body has at least one indicator representing a status of at least one of a process status, a component status, and an alert. A facilities interface panel coupled to the body has at least one connection for connecting the process chamber to a physical input or output. A mounting means coupled to the body is configured to engage corresponding mounting means of an enclosure of the integrated miniature factory.

In still another embodiment, a method for use with an integrated miniature factory is provided. The method comprises selecting a plurality of process modules from a plurality of available process modules for use in a fabrication process and inserting the selected process modules into an enclosure of the integrated miniature factory. Parameters are set for each of the inserted process modules, wherein the parameters define a behavior of each of the inserted process modules during the fabrication process, and the fabrication process is executed using the inserted process modules.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIGS. 1a-1f illustrate embodiments of an integrated miniature factory operable for fabricating microelectronic devices according to aspects of the present disclosure.

FIG. 2a illustrates an embodiment of an integrated miniature factory operable for fabricating microelectronic devices according to aspects of the present disclosure.

FIGS. 2b-2i illustrate embodiments of a process module that may be used in the integrated miniature factory of FIG. 2a.

FIGS. 3a-3d illustrate embodiments of a substrate and tray that may be used for handling a substrate according to aspects of the present disclosure.

FIGS. 4a and 4b illustrate embodiments of a transportation mechanism that may be used with an integrated miniature factory according to aspects of the present disclosure.

FIGS. 5a-5e are flow charts illustrating embodiments of processes that may be used for fabricating a microelectronic device using an integrated miniature factory according to embodiments of the present disclosure.

FIG. 5f is a flow chart illustrating one embodiment of a method for using an integrated miniature factory according to aspects of the present disclosure.

FIG. 6 illustrates an exemplary cross-sectional view of an integrated circuit that may be fabricated according to aspects of the present disclosure.

FIG. 7 illustrates one embodiment of a system that may be used with an integrated miniature factory according to aspects of the present disclosure.

FIG. 8 illustrates one embodiment of a graphical user interface tool adapted for managing activities of the system of FIG. 7.

FIG. 9 illustrates an exemplary general-purpose computer system suitable for operation within the system of FIG. 7.

### DETAILED DESCRIPTION

It is understood that the following disclosure provides many different embodiments or examples. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Furthermore, the figures are not necessarily drawn to scale, and in some instances the drawings have been exaggerated and/or simplified in places for illustrative purposes only.

The facilities and equipment required for fabricating advanced microelectronic devices requires enormous capital and few companies have the capital necessary to fabricate the most advanced microelectronic devices. The fabrication of advanced microelectronic devices is generally limited to tools that are designed for processing wafers of about 300 mm to 400 mm in diameter and such tools are large, complex, and expensive. Moreover, the development of new processes and tools used in the fabrication of advanced microelectronic devices typically requires substantial capital and resources. Due to reasons such as these, the fabrication of advanced microelectronic devices in low volume is typically not economically viable using these tools. Consequently, as microelectronic device technologies shrink and the manufacturing equipment increases in size to accommodate larger wafers to fabricate advance microelectronic devices, the ability to create new products in a timely manner and/or to create a wide variety of products is further limited.

Accordingly, the present disclosure contemplates an integrated miniature factory operable for fabrication of microelectronic devices. The integrated miniature factory includes a plurality of process modules operable for processing a substrate that may include a pre-cut rectangular slab of semiconductor material to form a microelectronic device. The integrated miniature factory is significantly smaller than a conventional factory. For example, the integrated miniature factory may occupy an area of about thirty feet by about sixty feet, whereas a conventional advanced microelectronic device factory may occupy an area of at least 480 feet by about 1080 feet (not including facilities). The integrated miniature factory may house various process modules in an inert particle-free environment. The process modules may be contained within the enclosure and may be readily removed from the enclosure and swapped out with other process modules. A transport mechanism may be included to transfer the substrate between process modules. The process modules may be configured for performing front-end semiconductor processes (i.e., the processes for making a microelectronic device prior to packaging) such as lithography, etch, deposition, and other processes. The substrates processed by the integrated miniature factory may be significantly smaller than wafers used in today's advanced microelectronic device factory. For example, the substrate may be a pre-cut rectangular substrate that is about the size of the surface area of a device being fabricated, and so may have a flat surface area of about 0.8 square inches. The integrated miniature factory may also process wafers of less than about two inches in diameter, and preferably about one inch in diameter in some embodiments. As the dimensions of the substrate are scaled-down, the size of the process modules and the enclosure may also be scaled-down. It is understood that the dimensions of the substrates may vary and that the ranges discussed herein are for purposes of example only.

The present disclosure also contemplates a system and method for simultaneously fabricating a variety of microelectronic devices. The integrated miniature factory may be partially or fully automated and one or more computerized systems may be used to control processes, maintain operational flows of substrates undergoing processing, and for providing an interface to a client for performing rapid proto-typing and fabrication of low volume products.

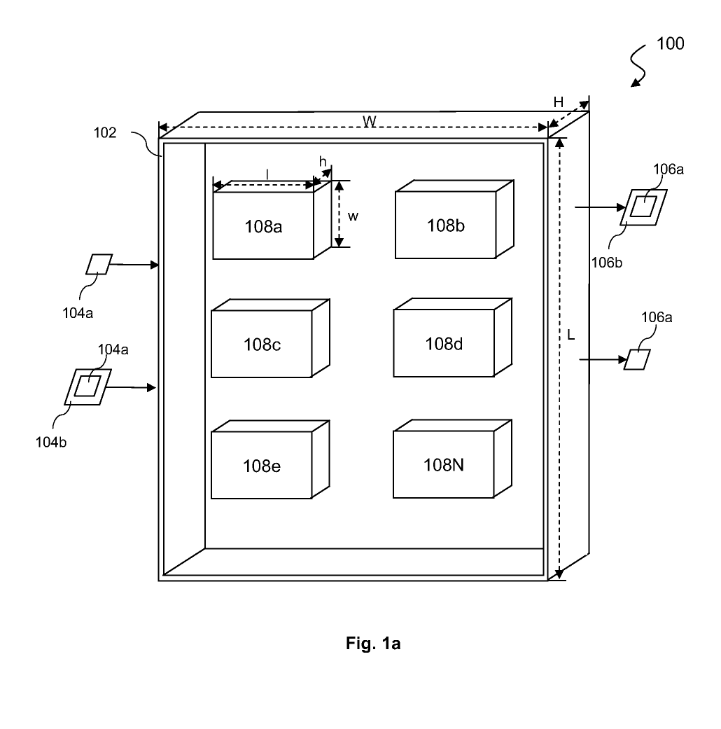

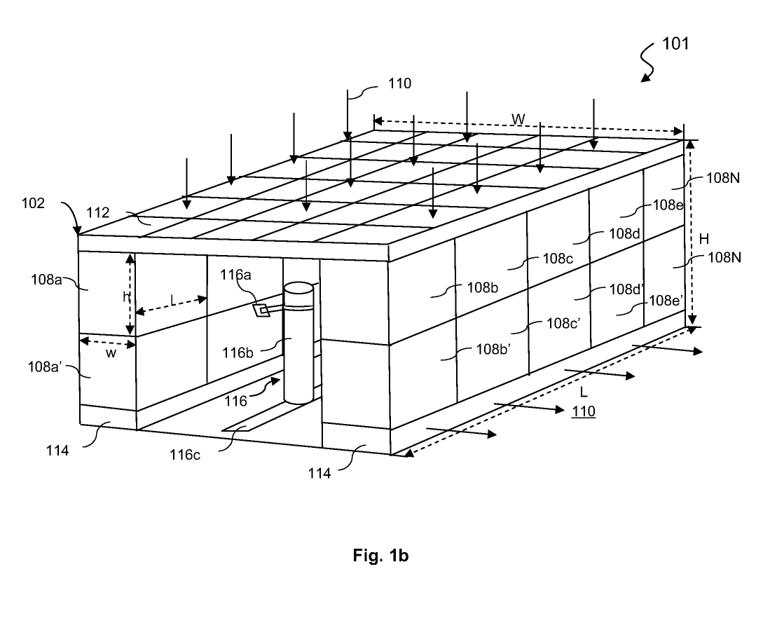

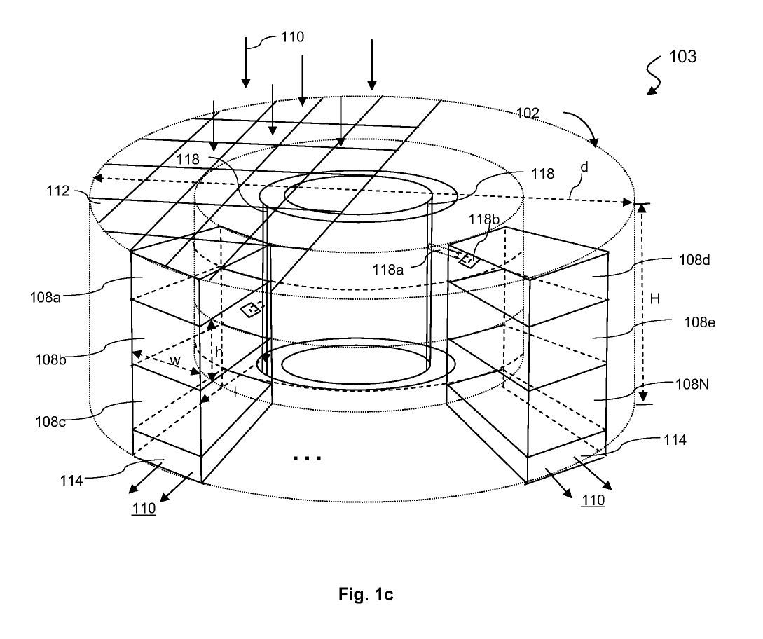

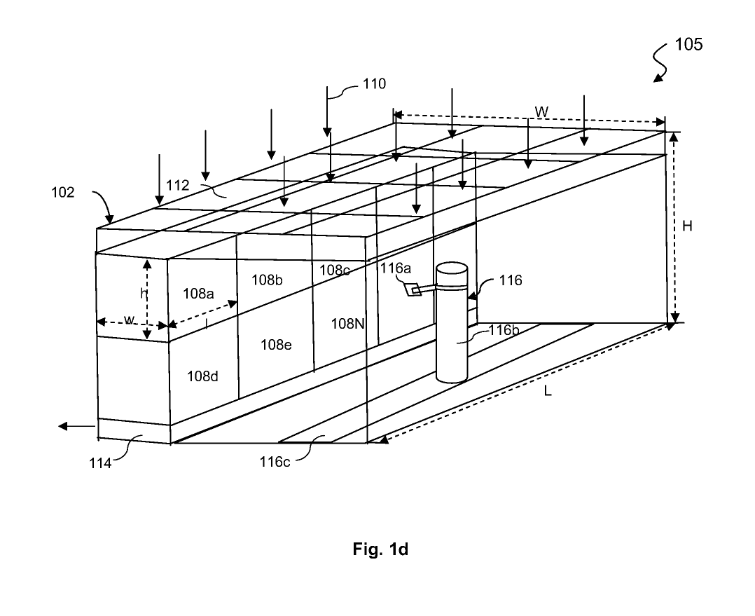

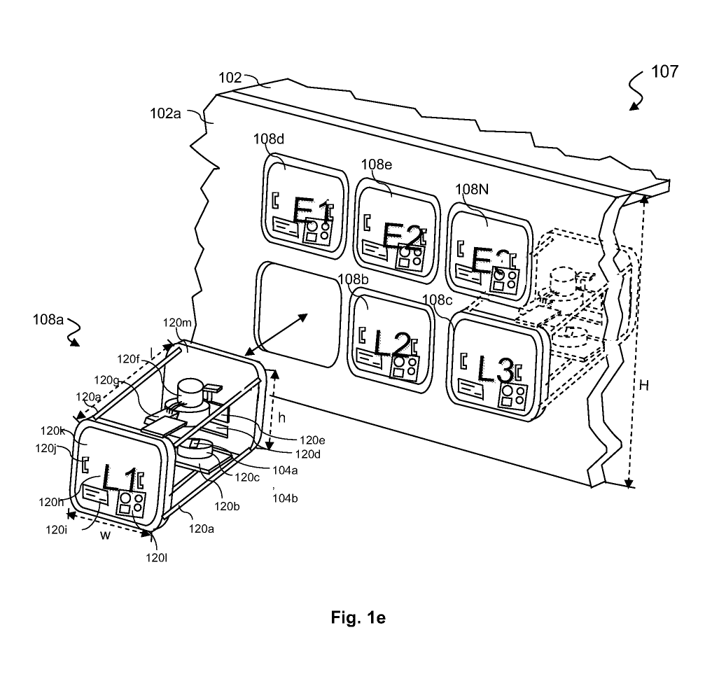

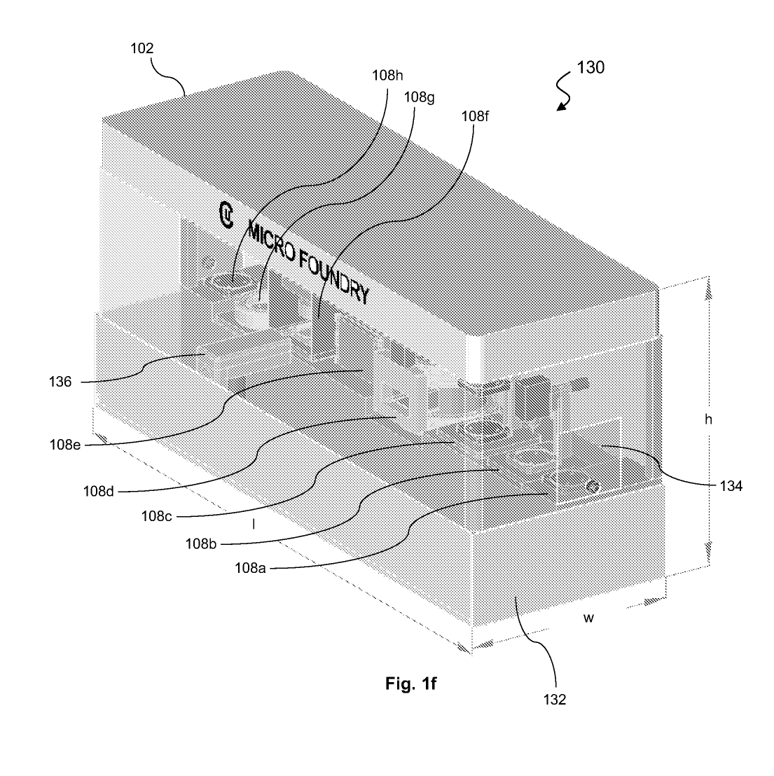

Referring to FIG. 1a, illustrated is one embodiment of an integrated miniature factory 100 having a plurality of process modules 108a, 108b, 108c, 108d, 108e, . . . , and 108N that are at least partially surrounded by an enclosure 102 operable for processing a substrate 104a. The integrated miniature factory 100 processes the substrate 104a through one or more of the process modules 108a-N to form a microelectronic device 106a. In some embodiments, the substrate 104a may be disposed on a tray 104b that is transferred between the process modules 108a-N. The tray 104b may be rectangular and may include pockets for holding multiple substrates and, in some embodiments, may include a secondary tray (not shown) located inside the tray 104b that may be removed with the substrate 104a from the tray 104b. The secondary tray may provide accurate alignment of the substrate 104a during alignment critical processes such as lithography. After undergoing processing in one or more of the process modules 108a-N, the formed microelectronic device 106a may be removed from the enclosure 102 on a tray 106b that may be identical or similar to the tray 104b.

The substrate 104a may have a variety of shapes and sizes depending, for example, on the microelectronic device to be manufactured or on other factors, such as material cost. For example, in some embodiments, the substrate 104a may be a “chicklet” (i.e., a small pre-cut rectangular substrate) having four flat sides with a length and width ranging from about 0.5 mm to about 102 mm, and a height ranging from about 0.1 mm to about 10 mm. The substrate 104a may include a base formed from a semiconductor material such as silicon, and may be shaped as a relatively flat rectangular piece that may be used to form the microelectronic device 106a. The substrate 104a may be rectangular with a surface area ranging from about 0.1 square inch to about four square inches. In another embodiment, the substrate 104a may include a wafer having a diameter ranging from about 12 mm to about 400 mm. The microelectronic device 106a formed on the substrate 104a may use a substantial portion of the substrate 104a or, alternatively, the substrate 104a may be processed through one or more of the process modules 108a-N to form multiple copies of the microelectronic device 106a on the substrate 104a.

As will be illustrated later in the present disclosure, the process modules 108a-N inside the enclosure 102 may be configured in different ways to minimize handling of the substrate 104a and to minimize the dimensions (length L, width W, and height H) of the enclosure 102. Although it may be desirable to minimize the footprint of the enclosure 102, it is understood that the enclosure may be constructed with pre-determined dimensions that may include a length L ranging from about three feet to about six hundred feet, a width W ranging from about two feet to about four hundred feet, and a height H ranging from about two feet to about twenty feet.

The enclosure 102 may include an array of high efficiency particle (HEPA) filters to provide a particle-free environment. Additionally or alternatively, the enclosure 102 may be sealed to provide an inert environment that allows for control of atmospheric conditions such as humidity. It is to be understood that the pre-determined dimensions of the enclosure 102 may be partially determined by the dimensions (length l, width w, and height h) of the process modules 108a-N.

Depending on the particular configuration of the enclosure 102, the process modules 108a-N may be stacked, grouped, or dispersed within the enclosure 102. A transport mechanism (not shown) for transferring the substrate 104a and/or the tray 104b may be present in one or more of the process modules 108a-N and/or may be located outside of the process modules 108a-N within the enclosure 102. For example, transferring of the substrate 104a between process modules 108a-N may be accomplished with a robotic arm having an end effector, or may be accomplished via other mechanisms such as a conveyor belt, a reel (e.g., the substrate 104a may reside on a continuous reel), or by aerodynamic levitation (e.g., an air cushion). In another embodiment, the substrate 104a may be transferred amongst the process modules 108a-N using the tray 104b. The tray 104b may include features such as holes or protrusions to enable mechanical grippers to hold and move the tray 104b. For example, the tray 104b may be moved along a set of tracks and the mechanical grippers may index the tray 104b between the process modules 108a-N.

The process modules 108a-N may each contain components configured to perform one or more processes operable for transforming the substrate 104a into the microelectronic device 106a. For example, the process modules 108a-N may include processes for patterning the substrate 104a, forming a material on the substrate, and/or removing a portion of the material and/or a portion of the substrate.

Patterning may be performed in one or more of the process modules 108a-N and may include forming a photosensitive material on the substrate 104a and exposing the photosensitive material to light or other sources of energy such as an ultra violet (UV) laser, an electron beam, or x-rays. In some embodiments, the patterning may include mechanically imprinting the photosensitive material on the substrate 104a. Alternatively, the patterning may include forming a polymer material on the substrate 104a that becomes insoluble when exposed to a laser beam having a frequency of about 520 nm or another suitable frequency. The focal length of the laser beam may be adjusted to create insoluble portions within the polymer material and enable the formation of three-dimensional features on the substrate 104a. In other embodiments, one or more of the process modules 108a-N may perform a “maskless” lithographic process whereby the feature to be formed on the substrate 104a is determined by direct writing with an electron beam, an x-ray, a laser, or by projection via a digital micro-mirror device (DMD) coupled with a UV light source. In this manner, the feature formed on the substrate may be altered to enable the formation of various features needed to fabricate various types of microelectronic devices or micro-electro-mechanical semiconductor (MEMS) devices.

The formation (used herein to include deposition) of the material on the substrate 104a may be performed in one or more of the process modules 108a-N. For example, the integrated miniature factory 100 may include multiple processes for forming layers or features using dielectric materials, metals, and other materials. One or more of the process modules 108a-N may include multiple processes coupled together in a mini-environment to prevent exposure of the substrate 104a and/or the material to the atmosphere while processing. For example, one or more of the process modules 108-N may include a mini-environment with a process reactor for forming a refractory barrier material such as titanium, titanium nitride, tantalum, or tantalum nitride coupled with a process reactor for forming a metal such as aluminum, copper, and/or other materials. It is to be understood that multiple processes may be performed within one process reactor provided by one of the process modules 108a-N. Processes for forming the material on a portion of the substrate 104a may include physical vapor deposition (PVD), chemical vapor deposition (CVD), plasma assisted chemical vapor deposition (PECVD), atomic layer deposition (ALD), spin-on dispense, and/or other processes.

The removal of a portion of the material from the substrate 104a may be performed in one or more of the process modules 108a-N. For example, patterned material may be etched by chemical or by plasma etch. Alternatively, a portion of the material may be removed by laser ablation or by other means such as chemical mechanical polishing (CMP). In some embodiments, the material formed on a portion of the substrate 104a may provide a mask to allow for a selected portion of the substrate 104a to be removed. The removal of a portion of the material may be performed in the same process module where the material was formed in a prior step. For example, the material may be formed within the process module 108a and in a later process step portions of the material may be also removed in the process module 108a. Alternatively, removal of material may be performed in a different one of the process modules 108a-N.

Referring to FIGS. 1b-1e, various embodiments of the integrated miniature factory 100 of FIG. 1a are illustrated in views 101, 103, 105, and 107, respectively, that each show a configuration of the integrated miniature factory 100 operable for processing the substrate 104a to form the microelectronic device 106a. It is understood that the following embodiments are merely examples of different configurations and that many other possible configurations, including combinations of the illustrated configurations, are possible.

Referring now specifically to FIG. 1b, the integrated miniature factory 100 illustrated in view 101 includes the enclosure 102 having a rectangle-shaped configuration with an array of HEPA filters 112 located over stacked rows of the process modules 108a-N, and additional process modules 108a′, 108b′, 108c′, 108d′, 108e′, and 108N′. In the present example, the stacked rows of process modules 108a-N and 108a′-N′ are located over a plenum platform 114. Air 110 flows into the enclosure 102 through the filters 112 and is exhausted through the plenum platform 114. Accordingly, the environment within the enclosure may contain very low levels of particulates and other contaminates that may damage the substrate 104a while undergoing processing through the process modules 108a-N and 108a′-N′. In another embodiment, the enclosure 102 may be fully sealed to prevent leakage of air in or out of the enclosure, which provides the ability to control such environmental factors as the humidity level within the enclosure.

In the present example, a robotic transfer mechanism 116 for transferring the substrate 104a between the process modules 108a-N and 108a′-N′ may be positioned between the two rows of process modules 108a-N and 108a′-N′. The robotic transfer mechanism 116 may include a retractable base 116b and end effector 116a positioned on a track 116c. The end effector 116a may include a gripping or other coupling mechanism to handle the substrate 104a and/or the tray 104b. In some embodiments, the robotic transfer mechanism 116 may not be located on the track 116c. Other embodiments may include multiple robots and/or conveyers to transfer the substrate 104a or the tray 104b within or between the process modules 108a-N and 108a′-N′. It is understood that at least portions of the robotic transfer mechanism 116 may be capable of two-dimensional or three-dimensional movement in order to move the substrate 104a and/or tray 104b to and from the process modules 108a-N and 108a′-N′.

Referring now to FIG. 1c, the integrated miniature factory 100 illustrated in view 103 includes the enclosure 102 configured in a circular shape with the process modules 108a-N stacked and positioned around a robotic transport mechanism 118. The filters 112 (e.g., HEPA filters) are located over the process modules 108a-N and may partially or totally cover the top surface of the enclosure 102. Air 110 may flow into the enclosure 102 through the filters 112 and be exhausted through plenum platform 114 or the enclosure 102 may be sealed. The robotic transport mechanism 118 may include one or more robotic systems that travel in a circle about the center of the enclosure 102. The enclosure 102 may include a diameter “d” ranging from about three feet to about six hundred feet, and a height H ranging from about one foot to about thirty feet.

In the present example, the robotic transport mechanism 118 may include at least one end effector 118a and a fixture 118b for handling the substrate 104a and/or the tray 104b. It is understood that the robotic transport mechanism 118 may include multiple robots capable of revolving about the center of the enclosure 102 to transport the substrate 104a to and from the plurality of process modules 108a-N. Furthermore, it is understood that at least portions of the robotic transfer mechanism 118 may be capable of two-dimensional or three-dimensional movement in order to move the substrate 104a and/or tray 104b to and from the process modules 108a-N.

Referring now to FIG. 1d, the integrated miniature factory 100 illustrated in view 105 includes the enclosure 102 with process modules 108a-N located against one wall of the enclosure 102. The process modules 108a-N may be stacked and the substrate 104a or the tray 104b may be transferred between the process modules 108a-N by the robotic transfer mechanism 116. Air 110 flows into the enclosure 102 through the filters 112 and is exhausted through the plenum platform 114. In another embodiment, the enclosure 102 may be fully sealed to prevent leakage of air in or out of the enclosure 102.

Positioned alongside the process modules 108a-N is a robotic transfer mechanism 116 for transferring the substrate 104a between the process modules 108a-N. In the present example, the robotic transfer mechanism 116 includes a retractable base 116b and end effector 116a positioned on a track 116c. The end effector 116a includes a gripping or other coupling mechanism to handle the substrate 104a and/or the tray 104b. In some embodiments, the robotic transfer mechanism 116 may not be located on the track 116c. Further embodiments may include multiple robots and conveyers to transfer the substrate 104a and/or the tray 104b within or between the process modules 108a-N. It is understood that at least portions of the robotic transfer mechanism 116 may be capable of two-dimensional or three-dimensional movement in order to move the substrate 104a and/or tray 104b to and from the process modules 108a-N.

Referring now to FIG. 1e, the integrated miniature factory 100 illustrated in view 107 includes the enclosure 102 with the process modules 108a-N positioned within a wall of the enclosure 102. The view 107 depicts an outside wall 102a of the enclosure 102, with the process modules 108a-N configured for installation and/or removal from the integrated miniature factory 100 via apertures in the exterior wall. Although not shown, it is understood that an aperture cover may be present if no process module is positioned in a particular aperture. Alternatively or additionally, a “dummy” process module may be inserted into an aperture.

The process modules 108a-N may be readily removed from the wall 102a of the enclosure 102 to perform maintenance, to swap locations within the enclosure 102, to change out one process for another process, or to perform an upgrade of the tool hardware. For example, one of the process modules 108a-N may include tooling to provide mask-based photolithography and may be removed and replaced with a process module that provides maskless-based electron beam lithography.

The process modules 108a-N may each include multiple components and systems for processing the substrate 104a. Since the process modules 108a-N may house complex systems for supporting semiconductor-based processes, the process modules 108a-N may require regular maintenance or other servicing. Accordingly, each of the process modules 108a-N may be removed from the enclosure 102 using handles 120j. For example, the process module 108a may be removed from the outside wall 102a of the enclosure 102 as shown.

In the present example, the process module 108a may include a body containing systems and components for electron beam lithography. The process module 108a includes face plates 120k and 120m supported by structural support rods 120a. The face plate 120k includes the handles 120j, a module identification number 120h, a tool status screen 120i, and a facilities interface panel 120l. The module identification number 120h may include alphanumeric characters identifying the type of process module and to specify the particular process module within a group of modules of the same process type. For example, process modules that pattern the substrate 104a may be identified by the letter “L”, process modules that remove a material may be identified by the letter “E”, and process modules that form a material may be identified by the letter “D”. It is understood that these are merely examples and that any combination of human or machine readable alphanumeric, symbolic, and/or other identifiers may be used.

The tool status screen 120i may include a touch sensitive liquid crystal display (LCD) that provides information such as real-time status information of the process module 108a. For example, the tool status screen 120i may include indicators for process status, component status, alerts, and/or other information associated with the process module 108a. The facilities interface panel 120l may include connections for interfacing with facilities to provide power, vacuum, gases, chemicals, and exhaust. For example, the facilities interface panel 120l may include a fitting for connection to a vacuum line or exhaust. The facilities interface panel 120l may also include fittings for the attachment of gas lines or compressed air. Since the process modules 108a-N are positioned within close proximity of each other within the enclosure 102, some or all of the facility resources may be shared. For example, the process modules 108d, 108e, and 108N may be attached to a common vacuum line backed by a single mechanical vacuum pump. In this manner, fewer facility resources may be necessary to operate each of the process modules 108a-N. Although not shown, it is understood that the process modules 108a-N may include connections for coupling to facility resources within the enclosure 102. For example, the process module 108a may include a protrusion or slot that engages a corresponding slot or protrusion inside the enclosure 102.

The face plate 120m includes an aperture such as a slit door 120d and a slit door actuator 120e to enable the substrate 104a to be removed or placed onto the stage 120c. Housed inside the process module 108a, the substrate 104a and/or the tray 104b may be disposed upon the stage 120c and an XYZ table 120b. Situated above the substrate 104a is an optics component 120f and supporting electronics 120g. The stage 120c may be circular or rectangular in shape and may include multiple trenches to prevent particles from being trapped between the substrate 104a and the stage 120c. The XYZ table 120b may include step motors and encoders operable for aligning the substrate 104a.

In one embodiment, the process module 108a may be adjustable with the structural support rods 120a having the ability to adjust the length l of the process module 108a. For example, the length l of the structural support rods 120a may be adjusted to support various process tool configurations. In various embodiments, the length l may be expandable up to about seventy-two inches, the width w may be expandable up to about thirty-six inches, and the height h may be expandable up to about thirty-six inches.

It is to be understood that the process modules 108a-N may include various processes for forming a material or removing the material from the substrate 104a. In other embodiments, some or all of the process modules 108a-N may contain components such as HEPA filters to aid in the creation of a particle-free environment within the process modules themselves.

Referring to FIG. 1f, the integrated miniature factory 100 illustrated in view 130 includes the enclosure 102 with process modules 108a-h located against one wall of the enclosure 102. A slot or other opening 132 may be present in an end wall 134 of the enclosure 102 to provide access to an interior of the enclosure. Although not shown, another slot or opening may be present in the opposite end wall or elsewhere. The additional opening may enable multiple enclosures to be positioned beside one another to provide an extended enclosure in which the substrate 104a may be moved from one enclosure to another during a fabrication process. A seal (e.g., an o-ring) (not shown) may be used to provide a seal between enclosures.

A robotic transfer mechanism 136 may be located inside the enclosure to transfer the substrate 104a between process modules 108a-h and to move the substrate into and out of the enclosure 102. The robotic transfer mechanism 136 may, for example, be capable of rotation around an axis and/or capable of vertical movement along the same axis. The robotic transfer mechanism 134 may also include an arm or other member that may extend and retract to position the substrate in one of the process modules 108a-h.

In the present example, the process modules 108a-h include a loading station 108a, a spin coater 108b, a lithography tool 108c, an oven 108d, a plasma tool 108e, a liner 108f, a hole driller 108g (e.g., a mechanical CNC machine), and an offloading station 108h. It is understood that these are merely examples and that fewer or more process modules may be used, and process modules with different functions may be used. The process modules 108a-h may be removable from the enclosure 102 or may be fixed within the enclosure 102.

The enclosure 102 has a length l, width w and height h. In the present example, the length l may be approximately fifty-three inches, the width w may be approximately eighteen inches, and the height h may be approximately twenty-five inches. However, it is understood that these dimensions are illustrative and may vary from those disclosed. For example, adding an additional process module to the existing row of process modules 108a-h would expand the length of the enclosure 102 by at least the size needed for the additional process module. In another example, adding an additional process module above or below the existing process modules 108a-h or rearranging the existing process modules may require additional changes to the enclosure's dimensions. Accordingly, the dimensions of the enclosure 102 may be defined at least partly by the number, size, and arrangement of the process modules to be contained therein.

In the preceding embodiments illustrated by FIGS. 1a-1f, it is understood that the process modules 108a-N and other process modules may be configured for installation and/or removal from the integrated miniature factory 100 in a variety of ways. For example, the integrated miniature factory 100 may include apertures, rails, shelves, and/or other coupling features to receive or otherwise integrate the process modules 108a-N with the integrated miniature factory, and corresponding features may be present on the process modules. Accordingly, the process modules 108a-N may be readily removed from the integrated miniature factory 100 to perform maintenance on the process modules and/or the integrated miniature factory, to swap locations within the integrated miniature factory, to change out one process for another process, or to perform an upgrade of the tool hardware. Alternatively, the process modules 108a-N may be fixed in a relatively permanent manner with the enclosure 102. The process modules 108a-N may be viewed as “compartmentalized” as each process module's body contains the needed components contained therein to perform its defined tasks in the enclosure 102.

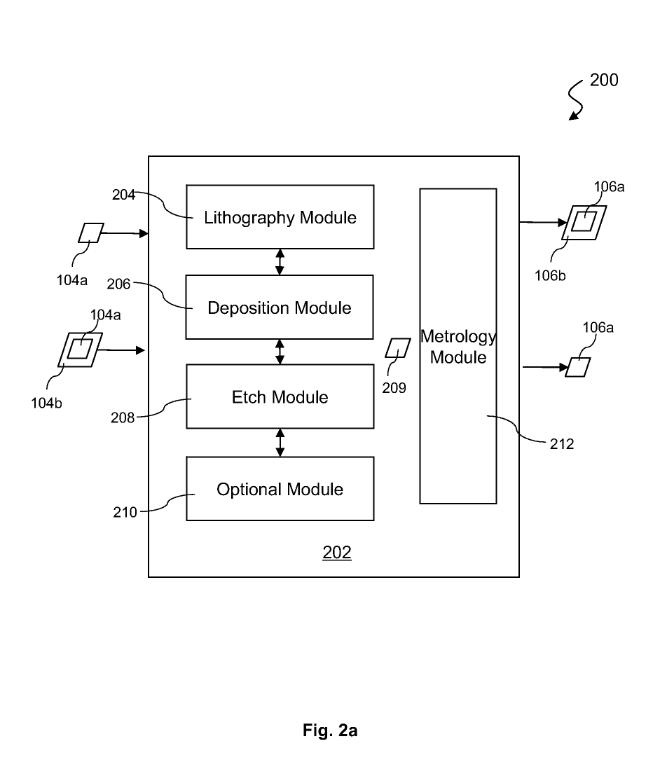

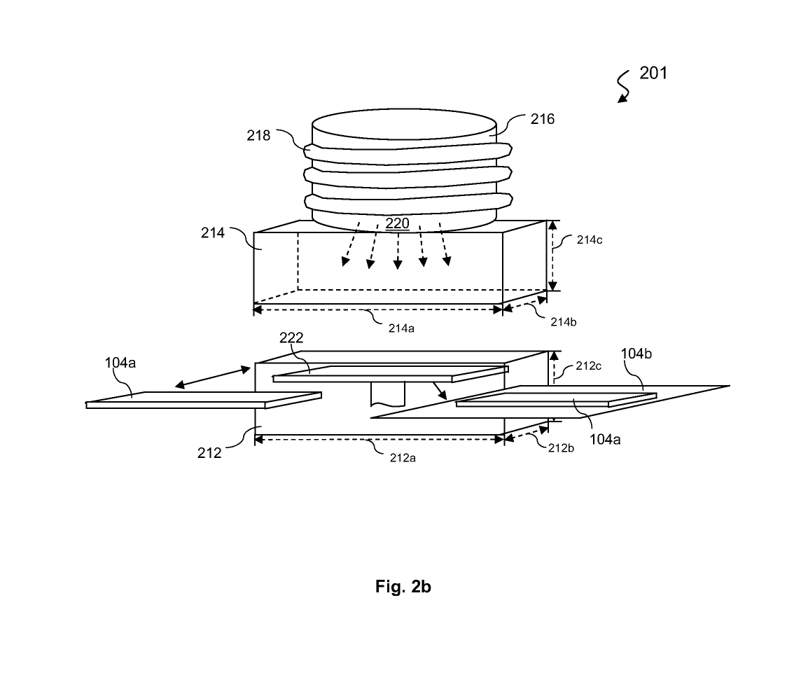

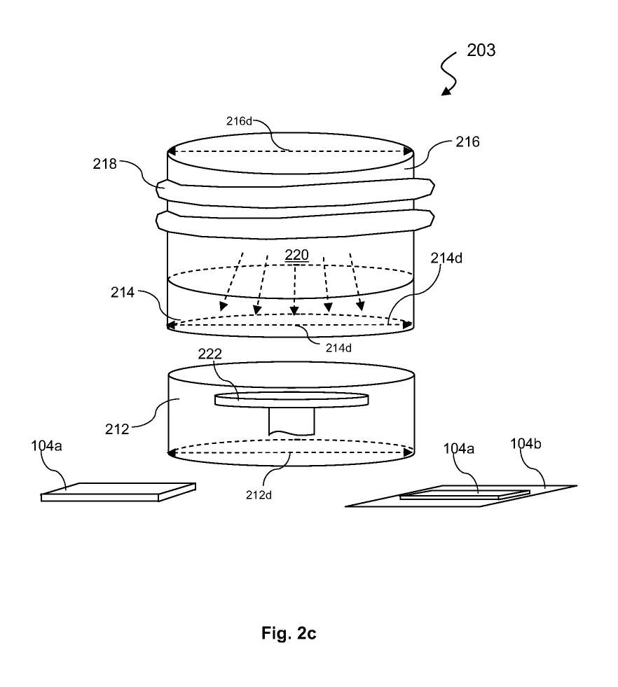

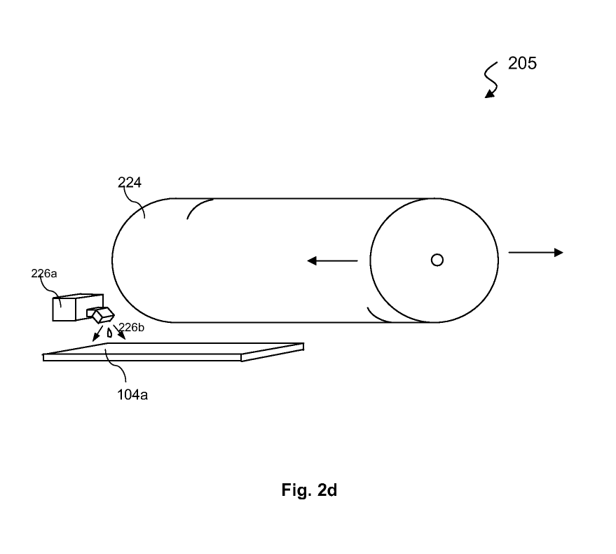

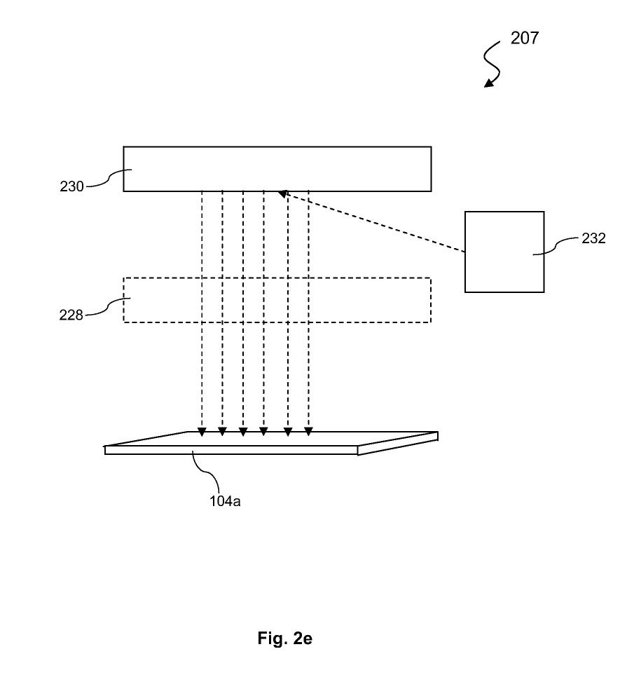

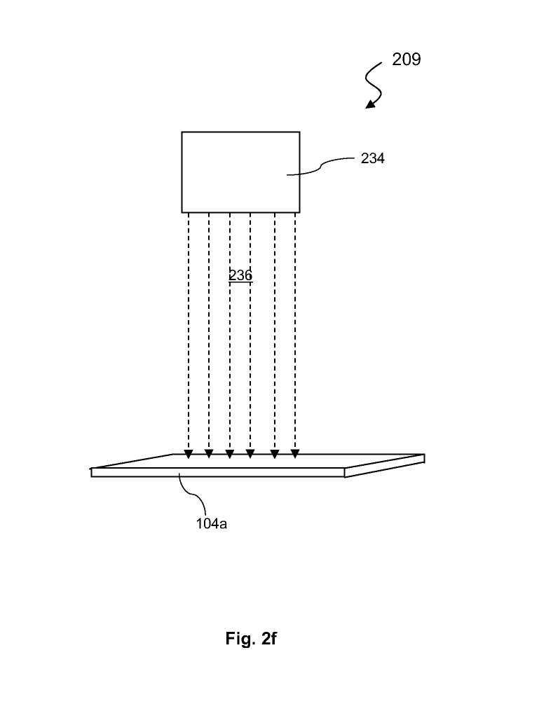

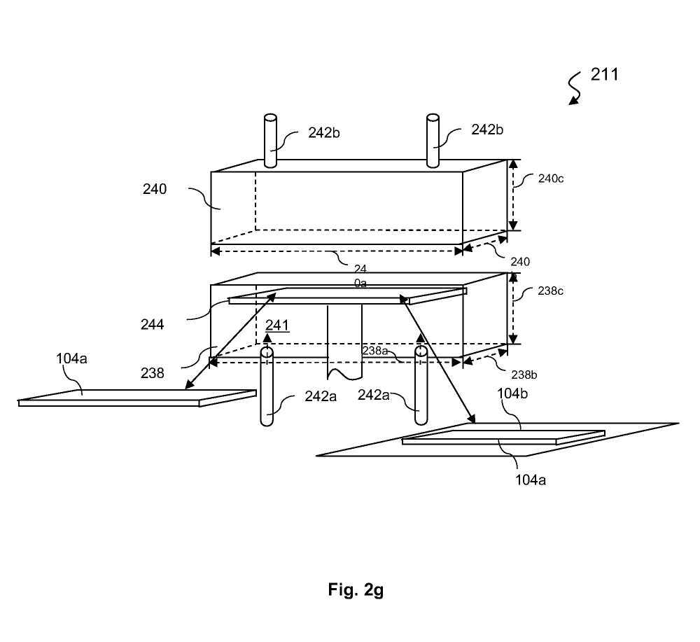

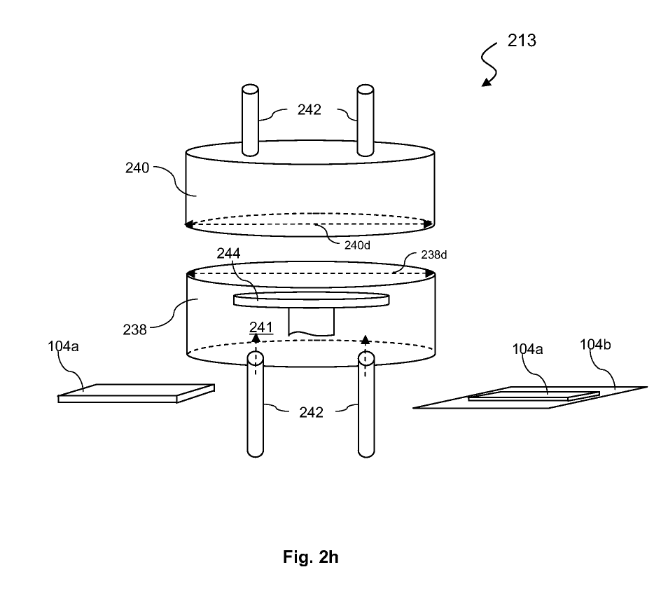

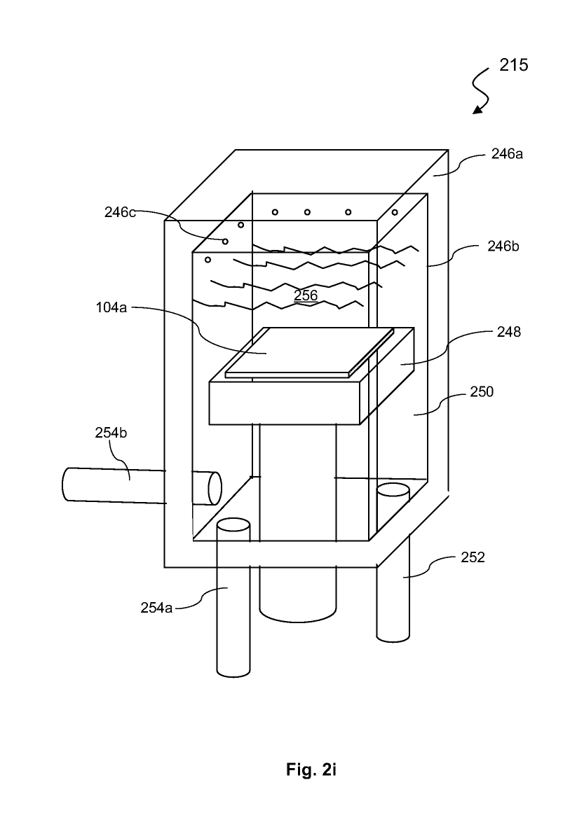

Referring to FIG. 2a, illustrated is one embodiment of an integrated miniature factory 200 having a lithography module 204, a deposition module 206, an etch module 208, a metrology module 212, and an optional module 210 surrounded by an enclosure 202. The integrated miniature factory 200 and modules 204, 206, 208, 210, and 212 may be substantially similar or identical to the integrated miniature factory 100 and the process modules 108a-N of FIG. 1a.

The lithography module 204 is configured to pattern the substrate 104a at multiple steps within a process flow that represents a series of steps required to fabricate the microelectronic device 106a. The lithography module 204 may perform one or more process steps needed for the process flow. For example, a first process step may include the deposition of photo resist or another polymer material, and a second step may include exposing the photo resist or polymer to UV light, UV laser, an electron beam, or another type of energy to transform selected portions of the deposited material to form a pattern.

The deposition module 206 is configured to perform one or more processes for forming a material on the substrate 104a. The process environment within the deposition module 206 may include one or more small reactors that may be about the size of the substrate 104a. For example, a process reactor within the deposition module 206 may include a volume of about 0.2 cubic inches up to about ten cubic inches. Generally, process chambers are significantly larger than the substrate and use large amounts of process gas and energy. In contrast, processing of the substrate 104a in the deposition module 206 may utilize relatively small amounts of process gas. For example, the process reactor may include a volume of about one cubic inch and so may use less than about one standard cubic centimeter per minute (sccm) of reactant gas or reactant carrier gas, whereas a conventional 300 mm wafer reactor may require more than 1000 sccm. Processes for forming the material on the substrate 104a may include PVD, CVD, PECVD, ALD, spin-on dispense, and/or other processes. Although not shown, the deposition module 206 may include multiple process chambers in a mini-environment for processes where the material being formed on the substrate may be sensitive to air.

The etch module 208, like the deposition module 206, may include one or more small reactor chambers having a volume of about 0.2 cubic inches up to about eighteen cubic inches. The etch module 208 may also include multiple process chambers in a mini-environment for processes where the material being formed on the substrate 104a may be sensitive to air. The etch module 208 may include plasma-based processes for removing materials from the substrate such as dielectrics and metals generally employed in semiconductor fabrication.

The optional module 210 may be configured to perform processes such as chemical mechanical polishing (CMP) or other processes required to form the microelectronic device 106a. As is known, CMP may be employed to planarize portions of the material on the substrate 104a during the formation of metal interconnects and metal/dielectric layers used to form electrical routing in the microelectronic device 106a. In some embodiments, the optional module 210 may include process reactors for altering an electrical characteristic of the material and/or the substrate 104a. For example, the optional module 210 may be configured to perform a thermal process using a diffusion reactor to dope selected portions of the substrate 104a with a P-type or N-type dopant. Alternatively, the optional module 210 may include a plasma immersion or ion implantation process reactor for altering an electrical characteristic of the material and/or the substrate 104a. In other embodiments, the optional module 110 may include one or more reactors for performing diffusion processes such as high temperature oxidation, diffusion of N-type dopants such as phosphorous or arsenic or P-type dopants such as boron. The diffusion process may include the processing of a single substrate or a batch of substrates. In still other embodiments, oxidation may be carried out in a single substrate reactor utilizing infrared (IR) lamps and high pressure, or by supercritical fluid oxidation.

In another embodiment, the optional module 110 may include a storage box for temporarily storing the substrate 104a between processes. For example, the substrate 104a or a partially built microelectronic device 209 may be stored between process steps for inspection in the metrology module 212. Alternatively, the substrate 104a or the partially built microelectronic device 209 may be temporarily stored to provide cycle-time balancing of material among the processes within the integrated miniature factory 200.

The metrology module 212 includes instruments for examining the substrate 104a during selected process steps. For example, the metrology module 212 may include an instrument such as x-ray fluorescence (XRF) to measure metal film thicknesses or an instrument to measure thicknesses of insulative materials including oxides, dielectrics, and/or other materials. The metrology module 212 may further include other instruments such as a multi-probe for testing electrical properties of the partially built microelectronic device 209.

The process of forming the material over the substrate 104a may be performed in the same process environment where portions of the material may be removed in a later etch process step. Accordingly, in some embodiments, the deposition module 206 and etch module 208 may be combined into a single process module within the integrated miniature factory 200. In other embodiments, the process for forming the material over the substrate 104a may be performed in the same process environment where portions of the material may be electrically altered. Accordingly, the deposition module 206 and etch module 208 may be combined into a single process module within the integrated miniature factory 200.

Although not shown, it is understood that many different process modules may be present in the integrated miniature factory 200 and that various processes may be combined into a single process module or placed in different process modules. Furthermore, the integrated miniature factory 200 may include multiple identical process modules and may not include every possible process module in a particular configuration.

Referring now to FIGS. 2b-2i, various embodiments of the modules 204, 206, 208, and 210 of the integrated miniature factory 200 are illustrated in configurations 201, 203, 205, 207, 209, 211, 213, and 215. The configurations 201, 203, 205, 207, 209, 211, 213, and 215 illustrate exemplary process environments within various ones of the modules 204, 206, 208, and 210 operable for processing the substrate 104a to form the microelectronic device 106a. In the present example, the configurations 201, 203, 205, 207, 209, 211, 213, and 215 may provide process environments with dimensions of about the size of the substrate 104a and/or tray 104b. For example, the process environment may include a volume ranging from one cubic inch to about eighteen cubic inches.

Referring specifically to FIGS. 2b and 2c, the respective configurations 201 and 203 illustrate an exemplary process environment that may be provided by the deposition module 206 and/or the etch module 208. As illustrated in FIG. 2b, an upper chamber 214 and a lower chamber 212 open and close to form a process environment to form and/or remove a material disposed on a portion of the substrate 104a. For purposes of example, the upper chamber 214 and lower chamber 212 may have respective lengths 212a and 214a, widths 212b and 214b, and heights 212c and 214c, each of which may range from about 0.5 inches to about eighteen inches. The upper chamber 214 may include a source 216 to provide reactants 220 for forming a material and/or removing a portion of the material from the substrate 104a. The source 216 may, for example, include an antenna 218 configured to transfer radio frequency (RF) power into the upper chamber 214 to energize the reactants 220. The reactants 220 may include energetic gas neutrals, ions, electrons, and/or non-energetic gas neutrals. In one embodiment, the source 216 may include other methods for providing energy to the reactants 220, including microwave, direct current (DC) or RF electrodes, and/or other techniques. The lower chamber 212 may include a pedestal 222 for supporting the substrate 104a or the tray 104b. The pedestal 222 may include a resistive element to heat the substrate 104a and may be coupled to a DC or RF power supply. IR lamps may also be located in the upper chamber 214 and/or the lower chamber 212 to provide energy to heat the substrate 104a.

In yet another embodiment, the configuration 201 may be employed to alter an electrical characteristic of the substrate 104a. For example, the optional pedestal 222 may be electrically biased with a high voltage power supply to direct highly energetic ions formed by the source 216 for implantation into a portion of the substrate 104a and/or a material on the substrate 104a. In this manner, electrically doped regions for sources, drains, lightly doped drains (LLD), or other electrically doped features common in microelectronic devices may be formed on the substrate 104a. Other methods may be employed to alter the electrical characteristics of the substrate 104a. For example, a high energy ion beam may be directed through the upper chamber 214 onto the substrate 104a.

Referring now to FIG. 2c, the configuration 203 may be similar to the configuration 201 of FIG. 2b with the exception that the upper chamber 214, the lower chamber 212, and the source 216 are cylindrical. In the present example, the upper chamber 214, the lower chamber 212, and the source 216 have respective diameters 212d, 214d, and 216d, which each may range from about one inch to about eighteen inches. In one embodiment, the upper chamber 214 and the lower chamber 212 may include stainless steel having about two inch diameter fittings and the source 216 may include a two inch diameter quartz or ceramic cylinder. The upper chamber 214 and the lower chamber 212 may include a single chamber having a slit valve door (not shown) to allow for the placement of the substrate 104a on to the pedestal 222.

Referring to FIG. 2d, the configuration 205 illustrates an exemplary process environment that may be provided by the optional module 210 or the etch module 208. A roller 224 with slurry 226b supplied by a slurry dispenser 226a may be employed to polish and/or etch a surface of the substrate 104a. For example, the roller 224 with the slurry 226b may be used to polish dielectric and metal material formed on the substrate. In one embodiment, the roller 224 may include a circular pad that rotates and is applied to the surface of the substrate 104a.

Referring to FIG. 2e, the configuration 207 illustrates an exemplary process environment that may be provided by the lithography module 204. In the present example, an imaging device 230 receives light from a source 232 to form an image on the substrate 104a through an optics component 228. In one embodiment, the imaging device 230 may include a digital micro-mirror device (DMD) and may receive data from a computer (not shown) to control the manipulation of mirrors of the DMD to dynamically project an image onto the substrate 104a. The source 232 may include a UV lamp, x-ray beam, or laser.

Referring to FIG. 2f, the configuration 209 illustrates an exemplary process environment that may be provided by the lithography module 204. In the present example, a source 234 provides an energetic beam 236 to form an image on the substrate 104a. The energetic beam 236 may include an electron beam or a laser beam. The configuration 209 may also include a system (not shown) for driving the source 234 to form a pattern on the substrate 104a. For example, the system may include a computer system having an interfacing subsystem and software applications executable thereon for altering the pattern formed on the substrate 104a in real-time.

Referring to FIG. 2g, the configuration 211 illustrates an exemplary process environment that may be provided by the etch module 208, the deposition module 206, and/or the optional module 210. In the present example, an upper chamber 240 and lower chamber 238 open and close to provide a process environment to form and/or remove a material disposed on a portion of the substrate 104a. The upper chamber 240 and lower chamber 238 may include respective lengths 238a and 240a, widths 238b and 240b, and heights 238c and 240c, which may each range from about 0.5 inches to about eighteen inches.

The upper chamber 240 and lower chamber 238 may be formed of chemical retardant materials such as teflon, quartz, glass, plastic, or other materials and may include a gasket or o-ring to provide a seal during processing. The upper chamber 240 and lower chamber 238 may be heated with one or more attached resistive heaters or other heater types (not shown). Chemical reactants 241 may be injected into or drained from the lower chamber 238 or upper chamber 240 by inlets 242a and 242b, respectively, to process the substrate 104a. The reactants 241 may include chemicals for removing the material from the substrate 104a such as hydrofluoric acid, de-ionized water, hydrochloric acid, sulfuric acid, or nitric acid. In some embodiments, the reactants 241 may also include solvents such as isopropyl alcohol or acetone. For example, de-ionized water may be injected into the lower chamber 238 by the lower inlets 242a and isopropyl alcohol may injected into the upper chamber 240 via the upper inlets 242b to clean and dry the substrate 104a. In some embodiments, the reactants 241 may include chemicals for forming the material on portions of the substrate 104a. For example, the reactants 241 may include electroless or electroplating solutions to form metals such as nickel, palladium, or gold. The lower chamber 238 may also include a pedestal 244 that may support the substrate 104a or the tray 104b during processing. The pedestal 244 may also include a resistive element to heat the substrate 104a.

Referring to FIG. 2h, the configuration 213 illustrates an exemplary process environment that may be provided by the etch module 208, the deposition module 206, and/or the optional module 210. The configuration 213 is similar to the configuration 211 with the exception that upper chamber 240 and the lower chamber 238 are cylindrical. In the present example, the upper chamber 240 and the lower chamber 238 have diameters 240d and 238d, respectively, each of which may range from about one inch to about eighteen inches.

It is understood that the configurations 211 and 213 of FIGS. 2g and 2h, respectively, may include a single chamber in place of the lower chamber 238 and the upper chamber 240, and may include a slit door valve to allow for placement of the substrate 104a onto the pedestal 244.

Referring to FIG. 2i, the configuration 215 illustrates an exemplary process environment that may be provided by the etch module 208, the deposition module 206, and the optional module 210. In the present example, the configuration 215 shows the substrate 104a located on a retractable pedestal 248 inside an outer tank 246a and an inner tank 246b. Attached to the outer tank 246a and the inner tank 246b are an inlet 252 and a drain 254a. Attached to the outer tank 246a is an overflow drain 254b. The substrate 104a may be held onto the pedestal 248 by vacuum while being etched or cleaned while immersed within a liquid 256. Nitrogen gas or the liquid 256 may be injected into the upper tank 246a by one or more holes 246c.

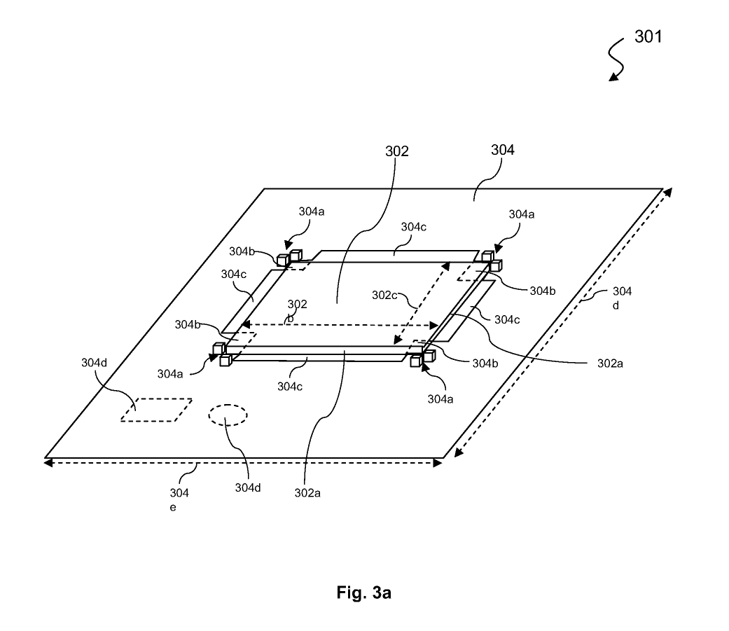

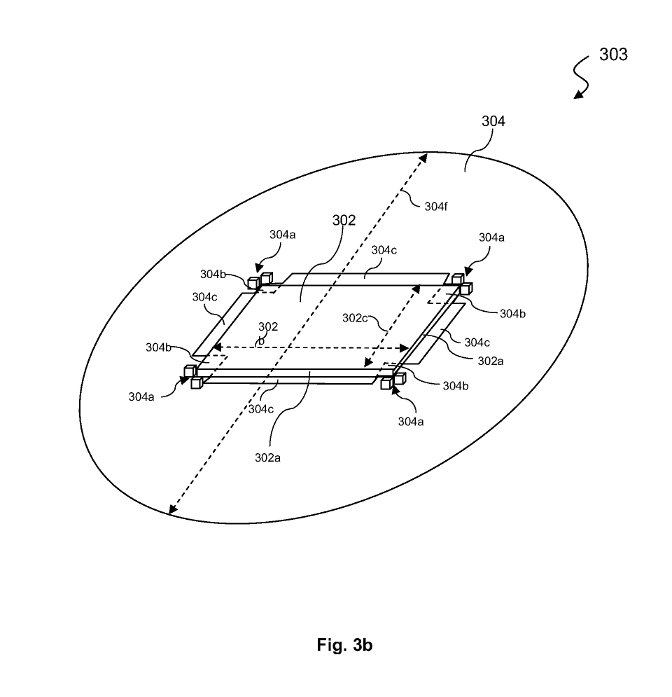

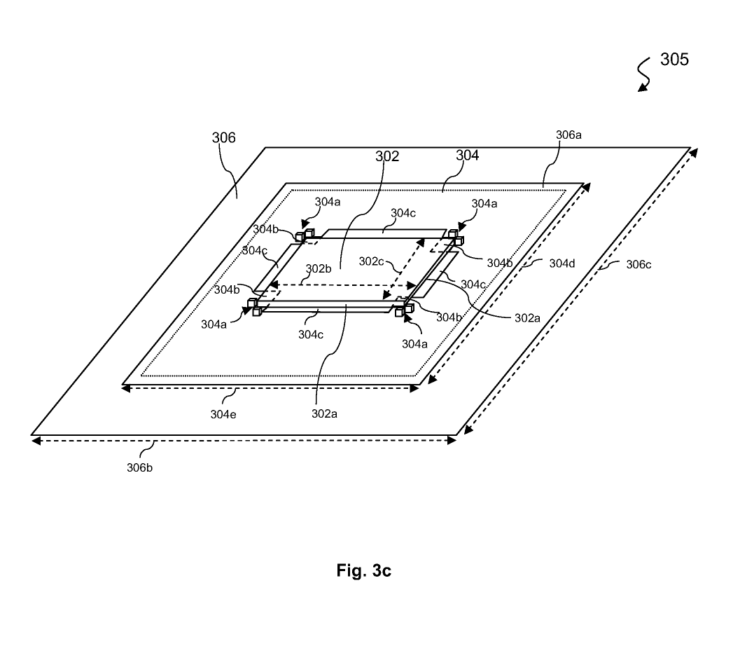

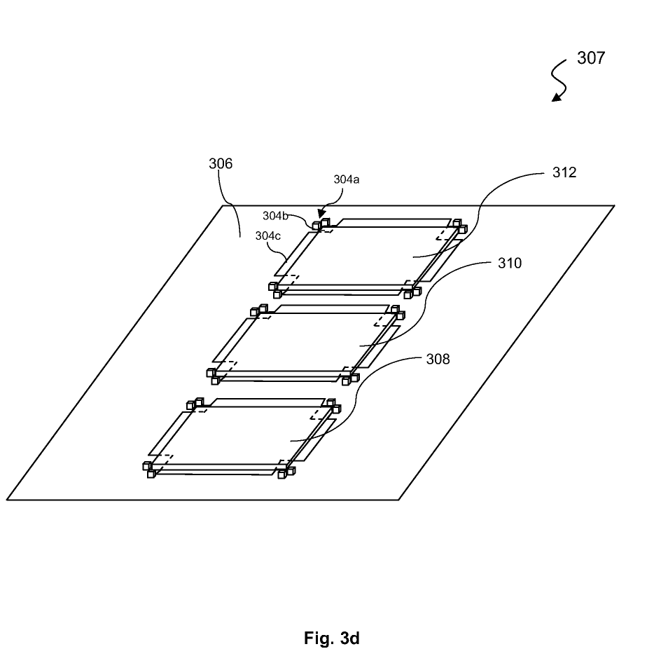

Referring to FIG. 3a, one embodiment of a carrier 301 is illustrated with a substrate 302 supported by a tray 304. For purposes of example, the substrate 302 and tray 304 are substantially similar to the substrate 104a and tray 104b of the integrated miniature factories 100 and 200 of respective FIGS. 1 and 2. The substrate 302 has a length 302b and a width 302c that may range from about 0.5 mm to about 102 mm and a thickness that may range from about 0.01 mm to about six mm. The substrate 302 may be supported by tray supports 304a and 304b at edges 302a of the substrate 302.

Openings 304c located between the edges 302a of the substrate 302 and the tray 302 may be present to allow for direct contact with the pedestal 222 or 244 in the configurations 201 (FIG. 2b) and 203 (FIG. 2c), respectively, during processing. The openings 304c may also allow for the passage of exhaust in the configurations 201 and 203. For example, the tray 304 may be clamped between the lower chamber 212 and the upper chamber 214 and the openings 304c may allow for effluents of the process to be exhausted through the lower chamber 212. The openings 304c may be rectangular, circular, and/or other shapes.

In the present example, the tray 304 has a length 304e and a width 304d that may each range from about 1.5 mm to about 164 mm, and a thickness that may range from about 0.005 mm to about six mm. The tray 304 may be formed from a variety of materials such as aluminum, titanium, quartz, glass, plastic, stainless steel, silicon carbide, other materials, and/or combinations thereof. In some embodiments, the tray 304 may include additional openings 304d that may be included to reduce the weight of the tray 304 and/or to provide passage of exhaust in the configurations 201 and 203. The openings 304d may be rectangular, circular, and/or other shapes. In other embodiments, the tray 304 may be circular with a diameter 304f ranging from about 1.5 mm to about 164 mm as depicted in the carrier 303 of FIG. 3b.

Referring to FIG. 3c, one embodiment of a carrier 305 is illustrated having the substrate 302 supported by the tray 304 and a parent tray 306. The parent tray 306 supports the backside of the tray 304 by a lip 306a. The parent tray 306 aids in protecting the tray 304 from damage during handling. In one embodiment, the tray 304 may include edges with high planar tolerances to help reduce the time that is required to align the substrate 302 during a lithographic process or another process. In this manner, the tray 304 with the substrate 302 may be removed from the parent tray 306 and placed onto a stage for alignment in order to form a pattern on the substrate 302 using the configurations 207 (FIG. 2e) and 209 (FIG. 2f). The tray 304 may provide rough alignment of the substrate 302 to the source 234 or imaging device 230, while fine alignment of the substrate 302 may be provided by the stage in the configurations 207 and 209. The parent tray 306 has a length 306b and a width 306c that may each range from about 100 mm to about 155 mm, and a thickness that may range from about 0.005 mm to about six mm. The tray 306 may be formed from a variety of materials such as aluminum, titanium, quartz, glass, plastic, stainless steel, silicon carbide, other materials, and/or combinations thereof.

Referring to FIG. 3d, illustrated is one embodiment of a carrier 307 having substrates 308, 310, and 312 supported by the tray 304. For purposes of example, the substrates 308, 310, and 312 and tray 304 are substantially similar to the substrate 104a and tray 104b of the integrated miniature factories 100 and 200 of respective FIGS. 1 and 2. As shown, multiple devices may be processed and/or handled in batches by using the carrier 307 in the integrated miniature factories 100 and 200.

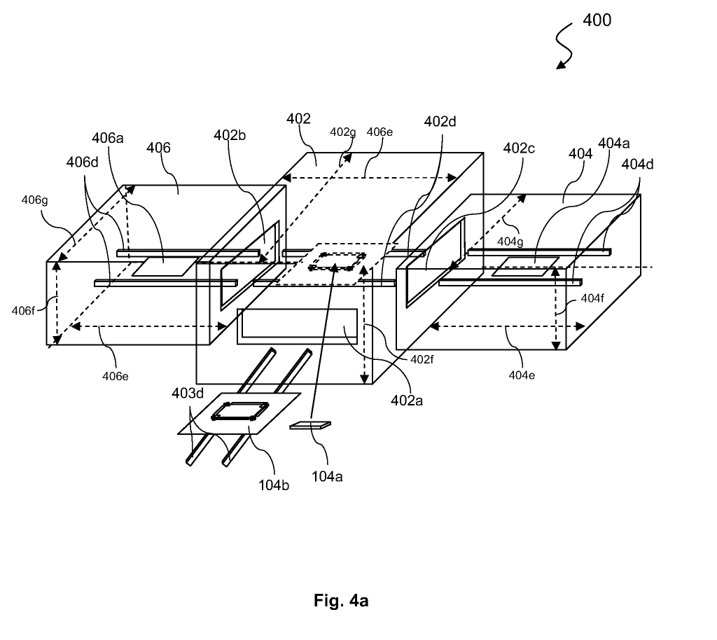

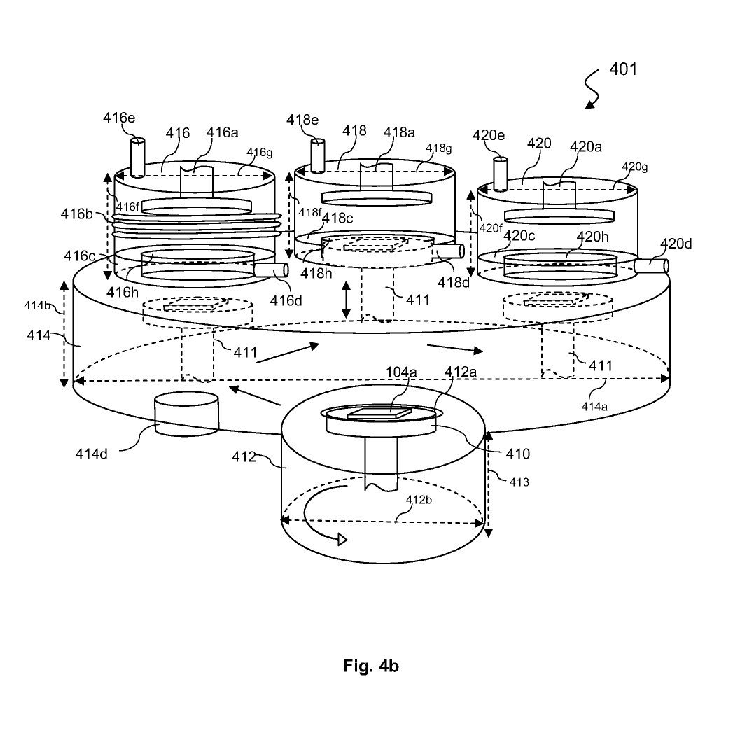

Referring to FIGS. 4a and 4b, views 400 and 401 illustrate embodiments of transportation mechanisms that may be used during fabrication of the microelectronic device 104b in the integrated miniature factories 100 and 200 of FIGS. 1 and 2, respectively. With specific reference to FIG. 4a, the view 400 depicts a rail-based transportation mechanism for transferring the substrate 104a and/or tray 104b to and from process modules 108a-N and 204-212. In the present example, the tray 104b having the substrate 104a positioned thereon may be transported on one or more rails 403d, 402d, 404d, and 406d into a load lock chamber 402 to be processed in process chambers 404 and 406. The load lock chamber 402 includes openings 402a, 402b, and 402c that provide access externally (opening 402a) and to process chambers 404 (opening 402c) and 406 (402b). The positioning of the openings 402a and 402c inside the load lock chamber 402 enable the process chambers 404 and 406 to be isolated from the environment in the enclosures 102 (FIG. 1) and 202 (FIG. 2a). In one embodiment, the process chambers 404 and 406 may include the deposition module 206, the etch module 208, and the optional module 210. The tray 104b may be guided along the rails 403d, 402d, 404d, and 406d by a movement mechanism such as one or more mechanical grippers or conveyor tracks. Once tray 104b is inside the process chamber 404 or 406, the tray 104b is placed onto a pedestal 404a or 406a, respectively. In the present example, the process chambers 404 and 406 include the dimensions 404e, 406e, 404f, 406f, 404g, and 406g, which may each range from about 0.5 inches to about eighteen inches.

Referring to FIG. 4b, the view 401 depicts a pedestal-based transportation mechanism for transferring the substrate 104a and/or the tray 104b to and from the process modules 108a-N and the 204-212. The substrate 104a or tray 104b may be disposed on a pedestal 410 in a first load lock chamber 412 that is positioned within or proximate to (e.g., underneath) a second lock load chamber 414. The first lock load chamber 412 may be capable of rotating an opening 412a to the atmosphere of the second load lock chamber 414 or to the atmosphere of the enclosures 102 and 202 of the integrated miniature factories 100 and 200, respectively.

The substrate 104a or tray 104b may be transferred from the pedestal 410 to a pedestal 411 inside the second load lock chamber 414 by a robotic arm or another movement mechanism (not shown). The pedestal 411 may move within the second load lock chamber 414 and actuate vertically to form a lower surface of process chambers 416, 418, and 420. The pedestal 411 may include resistive or IR heating elements and/or electrical cabling to provide a DC or RF electrical bias. The pedestals 410 and 411 may include one or more o-rings or gaskets to provide a seal between the pedestals 410 and 411 and the first load lock chamber 412, and the process chambers 416, 418, and 420. In some embodiments, the pedestal 410 may move into the second load lock chamber 414 and move into each of the process chambers 416, 418, and 420.

The first load lock chamber 412 has a diameter 412b that may range from about one inch to about twenty inches, and a height 413 that may range from about one inch to about eighteen inches. The second load lock chamber 414 may include an exhaust port 414d for evacuating the atmosphere inside of the second load lock chamber. The second load lock chamber 414 has a diameter 414a that may range from about three inches to about sixty inches, and a height 414b that may range from about 0.5 inch to about eighteen inches.

The process chambers 416, 418, and 420, respectively, may include a showerhead 416a, 418a, and 420a located over a pumping channel 416c, 418c, and 420c, and an opening 416h, 418h, and 420h to allow for placement of the pedestals 410 or 411. The showerheads 416a, 418a, and 420a may include one or more plates for dispersing reactants into the process chambers 416, 418, and 420. Alternatively, the showerheads 416a, 418a, and 420a may include a PVD target for sputtering materials such as tantalum, titanium, aluminum, or copper onto the substrate 104a. Gas inlets 416e, 418e, and 420e and exhaust lines 416d, 418d, and 420d may be attached to the respective process chambers 416, 418, and 420. The process reactor chambers 416, 418, and 420 have respective diameters 416g, 418g, and 420g that may range from about one inch to about eighteen inches and respective heights 416f, 418f, and 420f that may range from about one inch to about eighteen inches.

In some embodiments, the process chamber 416 includes an antenna 416b to provide RF power into the reactor. The process chamber 416 may be employed for removal of a material from the substrate 104a. For example, the process chamber 416 may be configured for the etching of oxide and/or polymer. Accordingly, vias or other features may be formed in the substrate 104a by plasma etching inside of process chamber 416. After the substrate 104a is processed in process chamber 416, the pedestal 410 or 411 may be moved to the process chamber 418 for formation of, for example, a barrier layer that may include tantalum and/or tantalum nitride. Subsequently, the pedestal 410 or 411 may be moved to the process chamber 420 for another process step such as the formation of copper over the barrier layer. The formed copper may be passivated by a nitrogen plasma that may also be formed in the process chamber 420.

It is understood that the process chambers 404 and 406 of FIG. 4a and the process chambers 416, 418, and 420 of FIG. 4b are not to be limited to the illustrated embodiments and may be configured for a variety of processes. Accordingly, the process chambers 404 and 406 and the process chambers 416, 418, and 420 may perform multiple processes, including forming or removing a material on the substrate 104a and altering an electrical characteristic of the substrate 104a. Furthermore, the process chambers 404 and 406 and the process chambers 416, 418, and 420 may be employed in the lithography module 204 (FIG. 2a) to form a pattern over the substrate 104a.

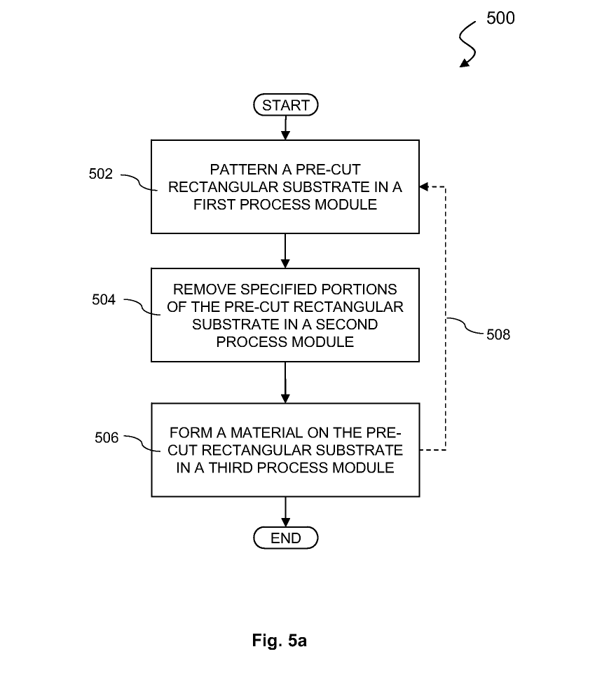

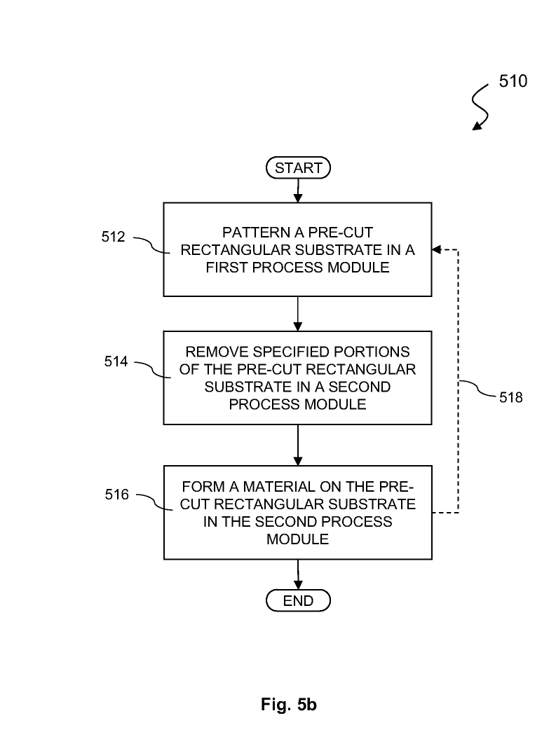

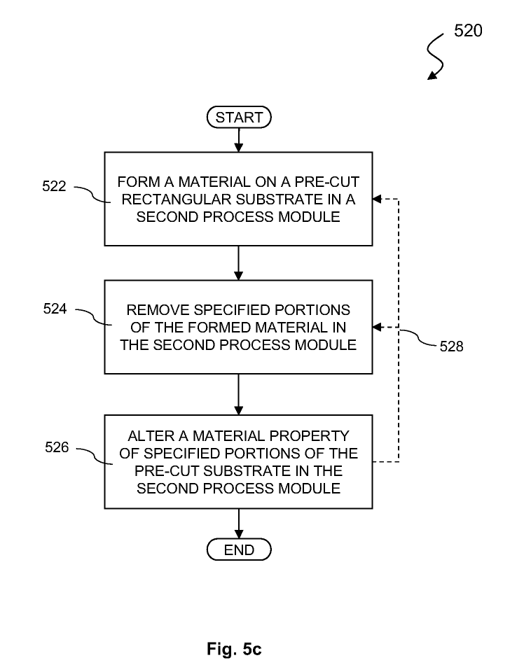

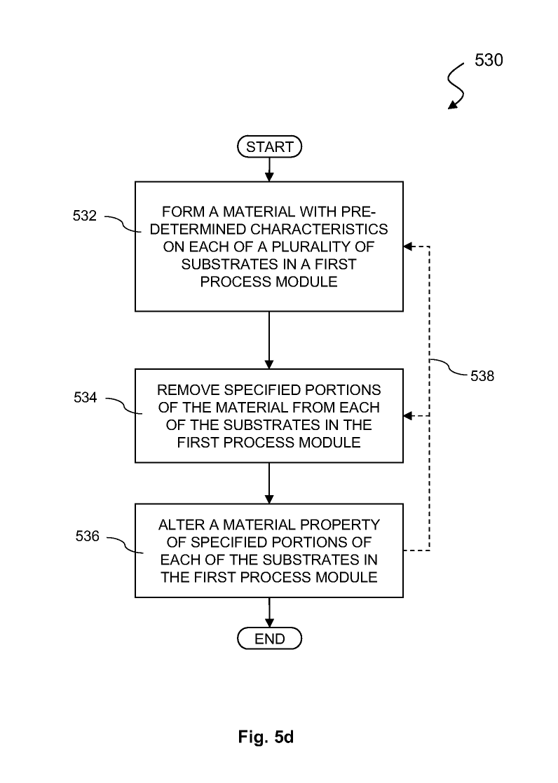

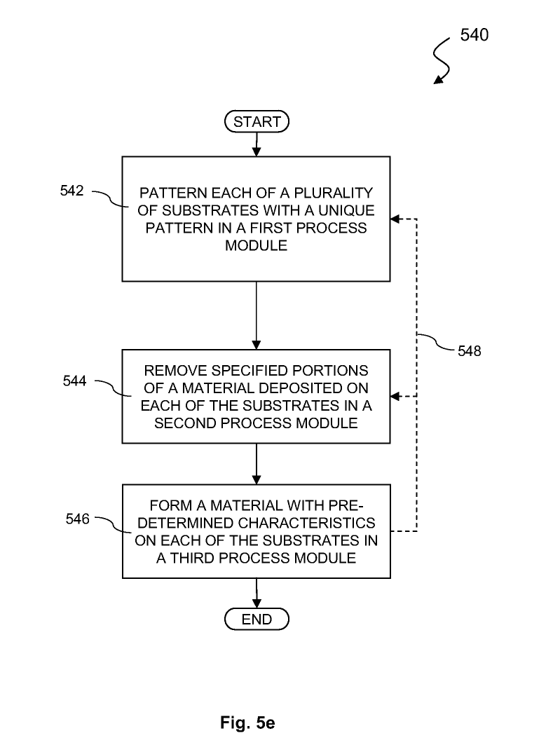

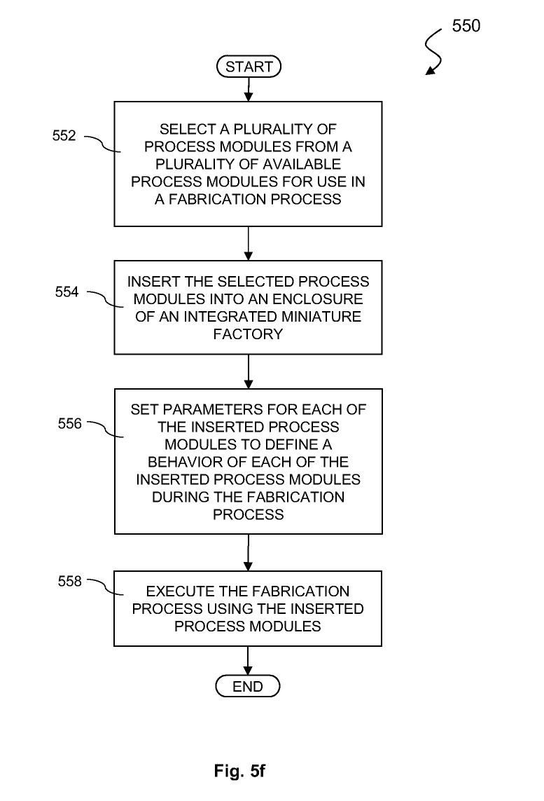

Referring to FIG. 5a, a flow chart illustrates one embodiment of a process 500 that may be used to form the microelectronic device 104b in the integrated miniature factories 100 and 200 of FIGS. 1 and 2a is shown. In the present example, the substrate 104a is a pre-cut rectangular substrate. In step 502, the substrate 104a is processed in a first process module such as the process module 108a or the lithography module 204 of the integrated miniature factories 100 or 200. For example, the substrate 104a may be coated with a photosensitive polymer material such as photo resist. The substrate 104a is coated with the material and then placed onto, for example, the stage 120c (FIG. 1e) for patterning in the process module 108a. The substrate 104a and the material may be patterned by mechanical imprint or selected portions of the material may be chemically altered to be insoluble by UV light, laser, or electron beam.

In step 504, selected portions of the substrate 104a are removed in a second process module such as the process module 108b or the etch module 208 of the integrated miniature factories 100 or 200. For example, selected portions of the substrate 104a may be etched in a sulfur hexafluoride and oxygen plasma to form trench isolation features to provide electrical isolation between N-type and P-type transistors of a complementary metal oxide semiconductor (CMOS) device. The substrate 104a may also include various materials and one or more of the materials may be removed by chemical or plasma etching with suitable chemistries that provide for removal of the material.

In step 506, a material may be formed over the substrate 104a in a third process module such as the process module 108c or deposition module 206 of the integrated miniature factories 100 or 200. The material may be formed over the substrate 104a or may be formed on selected portions of the substrate 104a. For example, the substrate 104a may include one or more vias or contacts positioned in an insulative material over the substrate 104a. These vias or contacts may be lined with a refractory metal such as tantalum, tantalum nitride or silicon carbide, and filled with a metal such as copper or aluminum. It is understood that other materials may be deposited over the substrate 104 in the third process module and the present disclosure is not limited to metals and may include other materials such as oxides including tetraethyl orthosilicate (TEOS) glass, porous or low-k glass, or other conductive, semi-conductive, or non-conductive materials such as carbon nanotubes. Once the material is formed over the substrate 104a, steps 502, 504, and 506 may be repeated a specified number of times (shown by line 508) through some or all of process modules 108a-N and/or the lithography module 204, the deposition module 206, the etch module 208, the optional module 210, and the metrology module 212.

Referring to FIG. 5b, a flow chart illustrates another embodiment of a process 510 that may be used to form the microelectronic device 104b in the integrated miniature factories 100 and 200. The process 510 is similar to the process 500 depicted in FIG. 5a with the exception that the removal of selected portions of the substrate 104a and the formation of the material may performed within the second process module. For example, the substrate 104a may be patterned in the process module 108a in step 512. Selected portions may be removed from the substrate 104a in the process module 108b and the material may then be formed over the substrate 104a in the process module 108b. The substrate 104a may remain on the pedestal 222 of configuration 201 (FIG. 2b) or 203 (FIG. 2c) after removing the selected portions of substrate 104a. The material may subsequently be formed over the substrate 104a in step 508 by CVD, PECVD, ALD or other techniques. Steps 512, 514, and 516 may be repeated a specified number of times (shown by line 518).

Referring to FIG. 5c, a flow chart illustrates yet another embodiment of a process 520 that may be used to form the microelectronic device 104b in the integrated miniature factories 100 and 200. The process 520 is substantially similar to the processes 500 and 510 depicted in FIGS. 5a and 5b, respectively, with the exception that the formation of the material and the removal of the material are performed in a second process module. For example, formation and removal as previously described may occur in steps 522 and 524, respectively, in process module 108b. In step 526, a material property of selected portions of the substrate 104a may be altered in process module 506b. The material property may include electrical conductivity or material stress. For example, ions may be implanted into the substrate 104a to form N-type or P-type doped areas by plasma source ion implantation. In one embodiment, the material stress of selected portions of the substrate 104a may be altered, for example, by the formation of silicon germanium or silicon nitride source and drain regions to induce stress on material located below a gate of a CMOS transistor. Alternatively, the material stress of selected portions of the substrate 104a may be stressed, for example, by the formation of a tensile or compressive silicon nitride layer over a transistor gate structure to increase mobility of charge carriers in the channels of NMOS or PMOS devices in some embodiments. Steps 522, 524, and 526 may be repeated a specified number of times (shown by line 528).

Referring to FIG. 5d, a flow chart illustrates yet another embodiment of a process 530 that may be used to form the microelectronic device 104b in the integrated miniature factories 100 and 200. In step 532, a material with pre-determined characteristics is formed on each one of a plurality of substrates in the first process module 108a. The material formed on each of the plurality of substrates may have differing characteristics from the materials formed on the other substrates. For example, the material formed on a first one of the substrates may have a first pre-determined thickness, while the material formed on a second one of the substrates may have a second pre-determined thickness that is different from the first pre-determined thickness.

In step 534, selected portions of each of the plurality of substrates are removed in the first process module. In some embodiments, the removal process chemistry may be different for each of the plurality of substrates. For example, the first substrate may have the selected portions removed using a first pre-determined process recipe, while a second substrate may have the selected portions removed using a second pre-determined process recipe. In this manner, the first substrate may be processed using an oxide etch recipe employing nitrogen trifluoride and oxygen plasma, while the second substrate may be processed using a silicon etch recipe employing hydrogen bromide, chlorine, oxygen, and/or helium plasma.

In step 536, a material property of selected portions of each of the plurality of substrates may be altered in the first process module. In some embodiments, the process recipe may be different for each of the plurality of substrates. For example, the first substrate may have the material property altered using a first pre-determined process recipe, while a second substrate may have the material property altered using a second pre-determined process recipe. In this manner, the first substrate may be processed using ion implantation of phosphorous, arsenic, or fluorine ions, while the second substrate may be processed using the deposition of silicon germanium or a tensile or compressive silicon nitride layer. Steps 532, 534, and 536 may be repeated a specified number of times (shown by line 538).

Referring to FIG. 5e, a flow chart illustrates yet another embodiment of a process 540 that may be used to form the microelectronic device 104b in the integrated miniature factories 100 and 200. In step 542, a pattern is formed on each one of a plurality of substrates in the first process module that may include the process module 108a or the lithography module 204 of the integrated miniature factories 100 and 200. In one embodiment, the plurality of substrates being processed may each have a different pattern. For example, a first substrate may include a first pattern and a second substrate may include a second pattern. The patterns may be formed by maskless lithographic techniques wherein patterns may be altered in real-time to enable the fabrication of various microelectronic devices.

In blocks 544 and 546, respectively, selected portions of each of the plurality of substrates are removed and the material is formed with the removal occurring in a second process module (e.g., the process module 108b or 208) and the formation occurring in a third process module (e.g., the process module 108c or 206).

Referring to FIG. 5f, a flow chart illustrates an embodiment of a method 550 that may be used to operate all or part of the integrated miniature factories 100 and 200. In step 552, a plurality of process modules are selected for use in a fabrication process. For example, process modules 108a-108d may be selected from a set of available process modules. In step 554, the selected process modules are inserted into an enclosure of the integrated miniature factory (e.g., into apertures in the enclosure 102 of FIG. 1e). In step 556, parameters may be set for each of the inserted process modules, where the parameters define a behavior of each of the inserted process modules during the fabrication process. In step 558, the fabrication process may be executed using the process modules. In some embodiments, inserting the process modules into the enclosure may include coupling the process modules to the enclosure by engaging each process module with a mounting feature (e.g., a rail, slot, or protrusion) of the enclosure. In another embodiment, a single substrate may be inserted into a transport system positioned within the enclosure, where the transport system transports the substrate from one inserted process module to another inserted process module.

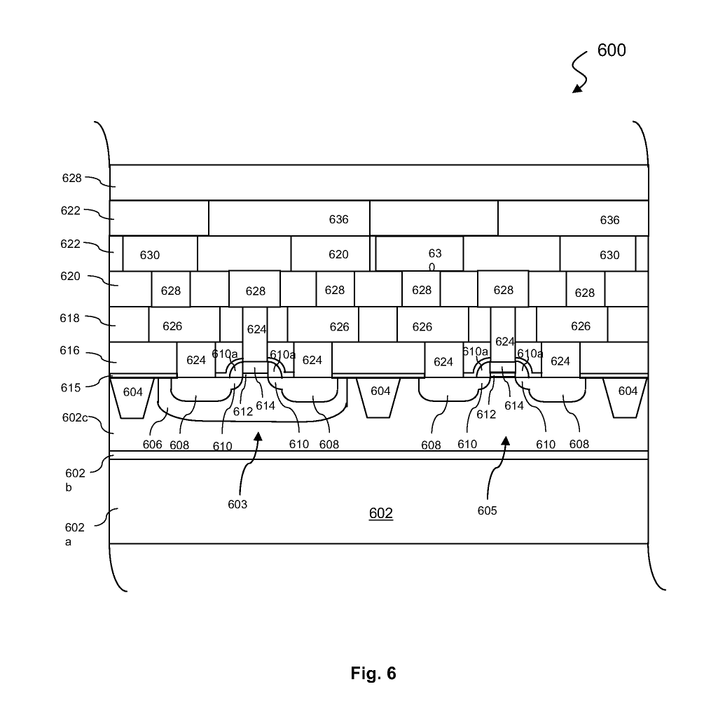

Referring to FIG. 6, a cross-sectional view of one embodiment of an integrated circuit 600 is illustrated that may be fabricated using one or more embodiments disclosed herein. A protective overcoat 628, bond pads 636, dielectric layers 616, 618, 620, and 622, and metal interconnects 624, 626, and 630 are disposed over a substrate 602 having microelectronic devices 603 and 605 interposing isolation trenches 604. The substrate 602 includes a base layer 602a, a buried oxide or dielectric layer 602b, and a top layer 602c. In one embodiment, the base layer 602a may include silicon, the dielectric layer 602b may include silicon dioxide, and the top layer 602c may include silicon. The microelectronic devices 603 and 605 also include a tensile or compressive layer 615 located over spacers 610a, source and drain doped regions 608, isolation trenches 604, a gate dielectric 612, and contact(s) 614 to increase charge mobility of the channel (area below the gate dielectric 612). The microelectronic devices 603 and 605 also include the source and drain doped regions 608 adjacent to lightly doped regions 610 (LLD) that are located below the spacers 610a. Between the spacers 610a, the gate dielectric 612, and the contact(s) 614 are disposed. The microelectronic device 603 may include a doped well 606 for preventing electrical latch-up and isolation from the microelectronic device 605.

For purposes of illustration, the previously described integrated miniature factories 100 and 200 may perform multiple processes to form the integrated circuit 600. For example, the isolation trenches 604, the spacers 610a, and gate dielectric 612 may be formed in the process module 108a, while the doped regions 608 and LLD 610 may be formed in the process module 108b. The dielectric layers 616, 618, 620, and 622 may be fabricated in the process module 108c, and the metal interconnects 624, 626, and 630, and bond pads 636 may be formed in the process module 108d.

It is understood that the integrated miniature factories 100 and 200 are not limited to the fabrication of the integrated circuit 600, but may also include MEMS devices, and/or other circuits existing now or in the future that may be created using fabrication steps that may be performed by the factories. Furthermore, the materials and processes employed for fabricating the integrated circuit 600 are not limited by the present disclosure.

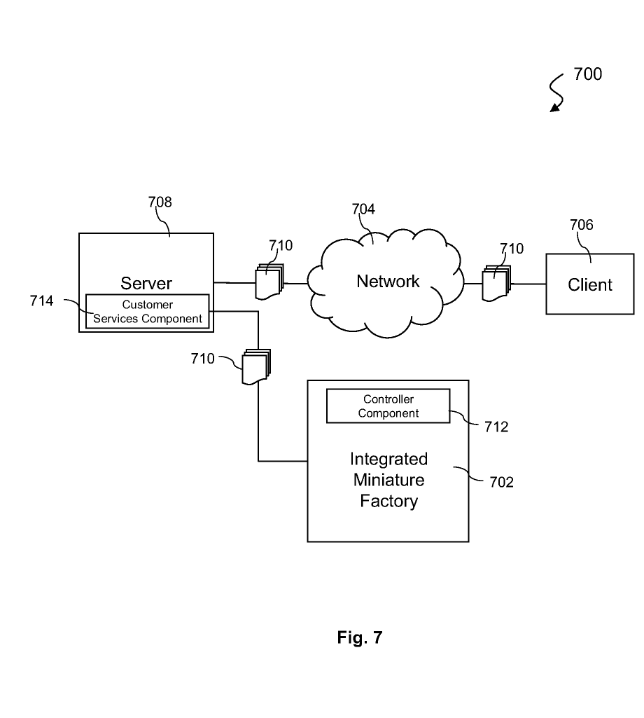

Referring to FIG. 7, one embodiment of a system 700 is illustrated for providing a client 706 the ability to remotely conduct business with an integrated miniature factory 702. In one embodiment, the integrated miniature factory 702 is substantially similar to the integrated miniature factories 100 and 200 of FIGS. 1a and 2a, respectively. The system 700 includes a server 708 in communication with a network 704, a controller component 712, and a customer services component 714. Transactions 710 are processed by the customer services component 714. The transactions 710 may include customer order information, device design and specifications, process flows, and process recipes. The transactions 710 may include mask data and processing conditions that may be processed by the controller component 712 to adjust process and tool settings for the process modules 108a-N or the lithography module 204, the deposition module 206, the etch module 208, the optional module 210, and the metrology module 212 of the integrated miniature factory 702. The client 706 may include a customer at a remote location, an administrator, or may include an engineer located at the integrated miniature factory 702 or elsewhere.

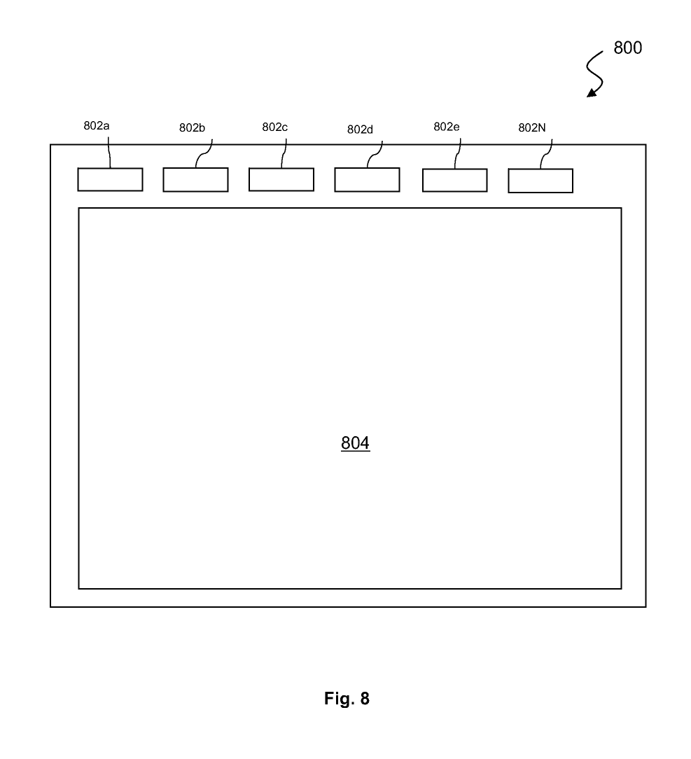

With additional reference to FIG. 8, a block diagram depicts one embodiment of a graphical user interface (GUI) 800 that may be used to access the controller component 712 of FIG. 7. The server 708 and/or other administrative entities may use the GUI 800 to access and/or operate aspects of the controller component 712, such as recipe master functionality provided by the controller component. The GUI 800 may operate on a general-purpose computer, a mobile device, and/or other device and may be coupled to the controller component 712 via a wireless or wired connection. The GUI 800 may include a web browser and/or another customized user interface. The GUI 800 may also be adapted for implementing one or more functions or operations associated with the integrated miniature factory 702 such as process recipe creation or statistical factory control charts associated with the processes performed within the integrated miniature factory 702. The GUI 800 may include viewing area 804 and buttons or links 802a, 802b, 802c, 802d, 802e, . . . , 802N that may correspond, for example, to process modules 108a-N. Alternatively, the buttons or links 802a, 802b, 802c, 802d, 802e, . . . , 802N may be for selecting process recipes, tools, time schedules, and similar information.

In some embodiments, the GUI 800 may provide the client 706 or system administrator a set of screens with which to monitor the status of an order in progress. For example, the viewing area 804 may include a list of material in process through the integrated miniature factory 702. The viewing area may also include one or more user inputs 802a, 802b, 802c, 802d, 802e, . . . , 802N for operating one or more operational aspects of the integrated miniature factory 702. For example, the client 706 may input the transactions 710 that may include device masks, film thicknesses, and other specific information necessary by the integrated miniature factory 702 to create the microelectronic device 106a. The client 706 may also delete or add orders or change the transactions 710. The GUI 800 may also be accessible through the tool status screen 120i of the view 107 depicted in FIG. 1e. For example, the GUI 800 may be operated on the tool status screen 120i to access recipes, tool diagnostics, and tool status associated with the process modules 108a-N.

The system 700 provides for rapid proto-typing and fabrication of low volume microelectronic devices. The development of new products may be performed automatically by using the system 700 and the GUI 800. For example, the client 706 may command the integrated miniature factory 702 to process a plurality of substrates to perform one or more design of experiments (DOE) to characterize processes contained within the integrated miniature factory 702 or to characterize electrical characteristics of a new product by altering film thickness, film compositions, dopant concentrations, or other device features. In this manner, a complex suite of tests and experiments may be provided to the integrated miniature factory 702 to automatically execute without the need for human interaction.

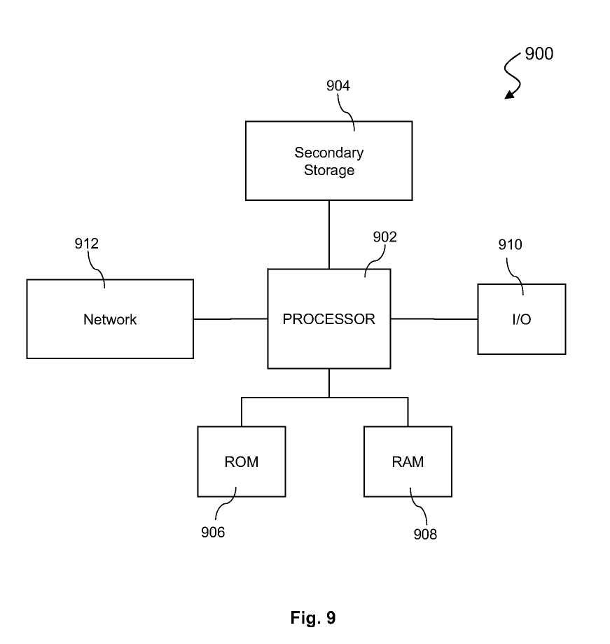

The system 700 and methods 500, 510, 520, 530, and 540 described above may be implemented on any computer with sufficient processing power, memory resources, and network throughput capability to handle the necessary workload placed upon it. FIG. 9 illustrates a typical, general-purpose computer system suitable for implementing one or more embodiments disclosed herein. The computer system 900 includes a processor 902 (which may be referred to as a central processor unit or CPU) that is in communication with memory devices including secondary storage 904, read only memory (ROM) 906, random access memory (RAM) 908, input/output (I/O) 910 devices, and network connectivity devices 912. The processor may be implemented as one or more CPU chips.

The secondary storage 904 typically includes one or more disk drives or tape drives and is used for non-volatile storage of data (e.g., for the methods and GUI described herein) and as an over-flow data storage device if RAM 908 is not large enough to hold all working data. Secondary storage 904 may be used to store programs, which are loaded into RAM 908 when such programs are selected for execution. The ROM 906 is used to store instructions and perhaps data that are read during program execution. ROM 906 is a non-volatile memory device, which typically has a small memory capacity relative to the larger memory capacity of secondary storage. The RAM 908 is used to store volatile data and perhaps to store instructions. Access to both ROM 906 and RAM 908 is typically faster than to secondary storage 904.

I/O 910 devices may include printers, video monitors, liquid crystal displays (LCDs), touch screen displays, keyboards, keypads, switches, dials, mice, track balls, voice recognizers, card readers, paper tape readers, or other well-known input devices. The network connectivity devices 912 may take the form of modems, modem banks, ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices. These network connectivity 912 devices may enable the processor 912 to communicate with an Internet or one or more intranets. With such a network connection, it is contemplated that the processor 912 might receive information from the network, or might output information to the network in the course of performing the above-described method steps. Such information, which is often represented as a sequence of instructions to be executed using processor 912, may be received from and outputted to the network, for example, in the form of a computer data signal embodied in a carrier wave.

Such information, which may include data or instructions to be executed using processor 912 for example, may be received from and outputted to the network, for example, in the form of a computer data baseband signal or signal embodied in a carrier wave. The baseband signal or signal embodied in the carrier wave generated by the network connectivity 912 devices may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 912 executes instructions, codes, computer programs, scripts that it accesses from hard disk, floppy disk, optical disk (these various disk based systems may all be considered secondary storage 904), ROM 906, RAM 908, or the network connectivity devices 912.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. An integrated miniature factory for fabrication of a device, comprising:
an enclosure;
a plurality of compartmentalized process modules configured to removably couple to the enclosure, wherein each of the compartmentalized process modules are sized to receive a substrate on which the device is to be fabricated, and wherein each of the compartmentalized process modules are configured to aid in fabrication of the device; and
a transportation mechanism configured to transfer the substrate between at least first and second compartmentalized process modules of the plurality of compartmentalized modules during a fabrication process.

2. The integrated miniature factory of claim 1 wherein the enclosure includes a filter covering an air intake to create a substantially particle-free environment containing the plurality of compartmentalized process modules within the enclosure.

3. The integrated miniature factory of claim 1 wherein the plurality of compartmentalized process modules each forms a substantially particle-free enclosure.

4. The integrated miniature factory of claim 1 wherein at least some of the plurality of compartmentalized process modules are rectangular in shape.

5. The integrated miniature factory of claim 4 wherein the rectangular compartmentalized process modules have a maximum length of approximately seventy-two inches, a maximum width of approximately thirty-six inches, and a maximum height of approximately thirty-six inches.

6. The integrated miniature factory of claim 1 wherein at least some of the plurality of compartmentalized process modules are cylindrical in shape.

7. The integrated miniature factory of claim 6 wherein the cylindrical compartmentalized process modules have a maximum diameter of approximately eighteen inches and a maximum height of approximately eighteen inches.

8. The integrated miniature factory of claim 1 wherein the substrate has a maximum diameter of approximately eighteen inches and wherein the compartmentalized process modules are configured to receive a substrate having a maximum size equal to that of the substrate.

9. The integrated miniature factory of claim 1 wherein the compartmentalized process modules are configured to reside in apertures located in a side wall of the enclosure.

10. The integrated miniature factory of claim 9 wherein each aperture is associated with a mounting feature configured to engage a corresponding mounting feature on each of the plurality of compartmentalized process modules.

11. The integrated miniature factory of claim 1 wherein at least one of the compartmentalized process modules includes a process reactor having a volume of approximately one cubic inch.

12. The integrated miniature factory of claim 11 wherein the process reactor uses a gas flow rate of less than approximately five standard cubic centimeters per minute (sccm) of a semiconductor processing gas during a fabrication process.

13. The integrated miniature factory of claim 1 wherein the enclosure includes an air flow path having an entry defined by a first external area of the enclosure and an exit defined by a second external area of the enclosure.

14. The integrated miniature factory of claim 1 wherein the enclosure is configured to be sealed during fabrication of the device.

15. A process module for use in an integrated miniature factory comprising:
a body;
a process chamber positioned within the body and sized to receive a substrate;
processing components positioned within the body and configured to perform processing on the substrate;
a tool status screen coupled to the body and having at least one indicator representing a status of at least one of a process, a component, and an alert;
a facilities interface panel coupled to the body and having at least one connection for connecting the process chamber to a physical input or output; and
mounting means coupled to the body and configured to engage corresponding mounting means of an enclosure of the integrated miniature factory.

16. The process module of claim 15 having a substantially rectangular shape with a maximum length of approximately seventy-two inches, a maximum width of approximately thirty-six inches, and a maximum height of approximately thirty-six inches.

17. The process module of claim 15 wherein at least one of a length, a width, and a height of the process module is adjustable.

18. A method for use with an integrated miniature factory comprising:
selecting a plurality of process modules from a plurality of available process modules for use in a fabrication process;
inserting the selected process modules into an enclosure of the integrated miniature factory;
setting parameters for each of the inserted process modules, wherein the parameters define a behavior of each of the inserted process modules during the fabrication process; and
executing the fabrication process using the inserted process modules.

19. The method of claim 18 wherein inserting the plurality of process modules into the enclosure includes coupling the process modules to the enclosure by engaging each process module with a mounting feature of the enclosure.

20. The method of claim 18 further comprising inserting a single substrate into a transport system positioned within the enclosure, wherein the transport system transports the substrate from one inserted process module to another inserted process module.
